(19) United States
(12) Patent Application Publication
(10) Pub. No.: US 2009/0313153 A1
(43) Pub. Date: Dec. 17, 2009

(54) Systems associated with projection system billing

(75) Inventors: Edward K.Y. Jung, Bellevue, WA (US); Eric C. Leuthardt, St. Louis, MO (US); Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US); Lowell L. Wood, JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware.

(21) Appl. No.: 12/291,025

(22) Filed: Oct. 30, 2008

Related U.S. Application Data
(63) Continuation-in-part of application No. 12/290,240, filed on Oct. 27, 2008.
Application No. 12/290,240 is a continuation-in-part of application No. 12/290,241, filed on Oct. 27, 2008.
Application No. 12/290,241 is a continuation-in-part of application No. 12/291,019, filed on Oct. 30, 2008.
Application No. 12/291,019 is a continuation-in-part of application No. 12/291,024, filed on Oct. 30, 2008.
Application No. 12/291,024 is a continuation-in-part of application No. 12/291,023, filed on Oct. 30, 2008.
Application No. 12/291,023 is a continuation-in-part of application No. 12/214,422, filed on Jun. 17, 2008.

(51) Int. Cl. G06Q 30/00; G06Q 50/00

(52) U.S. Cl. 705/34

(57) ABSTRACT

The present disclosure relates to systems and methods that are associated with billing one or more fees that are related to projection.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### Related Applications:

For purposes of the USPTO extra-statutory requirements, the present application constitutes a continuation-in-part of U.S. patent application Ser. No. 12/214,422, entitled SYSTEMS AND DEVICES, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 17 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,118, entitled MOTION RESPONSIVE DEVICES AND SYSTEMS, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,116, entitled SYSTEMS AND METHODS FOR PROJECTING, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,115, entitled SYSTEMS AND METHODS FOR TRANSMITTING INFORMATION ASSOCIATED WITH PROJECTING, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,123, entitled SYSTEMS AND METHODS FOR RECEIVING INFORMATION ASSOCIATED WITH PROJECTING, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,135, entitled SYSTEMS AND METHODS FOR PROJECTING IN RESPONSE TO POSITION, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,117, entitled SYSTEMS AND METHODS FOR PROJECTING IN RESPONSE TO CONFORMATION, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,269, entitled SYSTEMS AND METHODS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,266, entitled SYSTEMS AND METHODS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,267, entitled SYSTEMS AND METHODS FOR PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,268, entitled SYSTEMS AND METHODS FOR PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/220,906, entitled METHODS AND SYSTEMS FOR RECEIVING AND TRANSMITTING SIGNALS ASSOCIATED WITH PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 28 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,534, entitled PROJECTION IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,518, entitled PROJECTION IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,505, entitled METHODS AND SYSTEMS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,519, entitled METHODS AND SYSTEMS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,536, entitled METHODS AND SYSTEMS FOR PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,508, entitled METHODS AND SYSTEMS FOR PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/286,731, entitled PROJECTION ASSOCIATED METHODS AND SYSTEMS, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Sep. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/286,750, entitled PROJECTION ASSOCIATED METHODS AND SYSTEMS, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Sep. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. UNKNOWN, entitled METHODS ASSOCIATED WITH RECEIVING AND TRANSMITTING INFORMATION RELATED TO PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. UNKNOWN, entitled SYSTEMS ASSOCIATED WITH RECEIVING AND TRANSMITTING INFORMATION RELATED TO PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. UNKNOWN, entitled METHODS ASSOCIATED WITH PROJECTION BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. UNKNOWN, entitled SYSTEMS ASSOCIATED WITH PROJECTION BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. UNKNOWN, entitled METHODS ASSOCIATED WITH PROJECTION SYSTEM BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### TECHNICAL FIELD

The present disclosure relates to systems and methods that are associated with billing one or more fees that are related to projection.

### SUMMARY

In one aspect, a method includes but is not limited to receiving one or more requests related to use of one or more user-directed projectors and billing one or more accounts in response to the one or more requests related to use of one or more user-directed projectors. In some embodiments, the method may optionally include transmitting one or more instructions related to the one or more requests related to use of the one or more user-directed projectors. In addition to the foregoing, other aspects are described in the claims, drawings, and text forming a part of the present disclosure.

In one aspect, a system includes but is not limited to circuitry for receiving one or more requests related to use of one or more user-directed projectors and circuitry for billing one or more accounts in response to the one or more requests related to use of one or more user-directed projectors. In some embodiments, the system may optionally include circuitry for transmitting one or more instructions related to the one or more requests related to use of the one or more user-directed projectors. In addition to the foregoing, other aspects are described in the claims, drawings, and text forming a part of the present disclosure.

In one aspect, a system includes but is not limited to means for receiving one or more requests related to use of one or more user-directed projectors and means for billing one or more accounts in response to the one or more requests related to use of one or more user-directed projectors. In some embodiments, the system may optionally include means for transmitting one or more instructions related to the one or more requests related to use of the one or more user-directed projectors. In addition to the foregoing, other aspects are described in the claims, drawings, and text forming a part of the present disclosure.

In one aspect, a system includes but is not limited to a signal-bearing medium bearing one or more instructions for receiving one or more requests related to use of one or more user-directed projectors and one or more instructions for billing one or more accounts in response to the one or more requests related to use of the one or more user-directed projectors. In some embodiments, the system may optionally include one or more instructions for transmitting one or more instructions related to the one or more requests related to use of the one or more user-directed projectors. In addition to the foregoing, other aspects are described in the claims, drawings, and text forming a part of the present disclosure.

In one or more various aspects, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein referenced method aspects depending upon the design choices of the system designer. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system 100 in which embodiments may be implemented.

FIG. 1A illustrates embodiments of components shown in FIG. 1.

FIG. 1B illustrates embodiments of components shown in FIG. 1.

FIG. 1C illustrates embodiments of components shown in FIG. 1.

FIG. 1D illustrates embodiments of components shown in FIG. 1.

FIG. 2 illustrates an operational flow 200 representing example operations related to receiving one or more requests related to use of one or more user-directed projectors and billing one or more accounts in response to the one or more requests related to use of one or more user-directed projectors.

FIGS. 3-6 illustrate alternative embodiments of the example operation flow of FIG. 2.

FIG. 7 illustrates an operational flow 700 representing example operations related to receiving one or more requests related to use of one or more user-directed projectors, billing one or more accounts in response to the one or more requests related to use of one or more user-directed projectors, and transmitting one or more instructions related to the one or more requests related to use of the one or more user-directed projectors.

FIGS. 8-10 illustrate alternative embodiments of the example operation flow of FIG. 7.

FIG. 11 illustrates a partial view of a system 1100 that includes a computer program for executing a computer process on a computing device.

FIG. 12 illustrates a partial view of a system 1200 that includes a computer program for executing a computer process on a computing device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

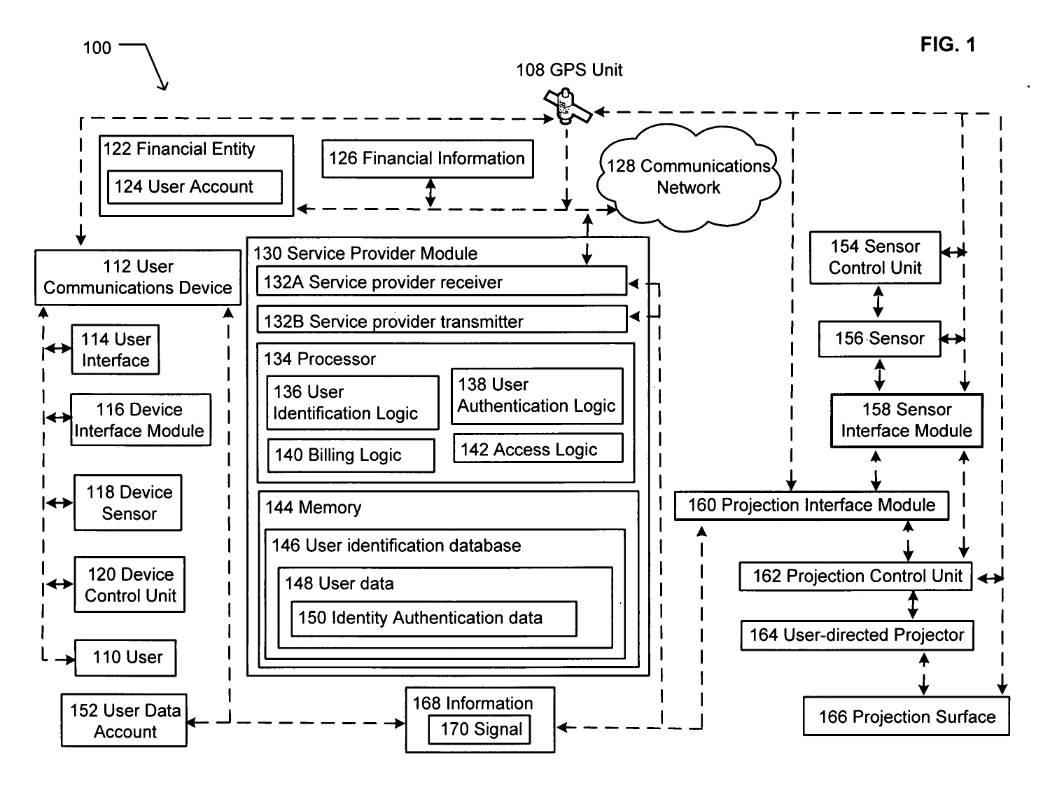

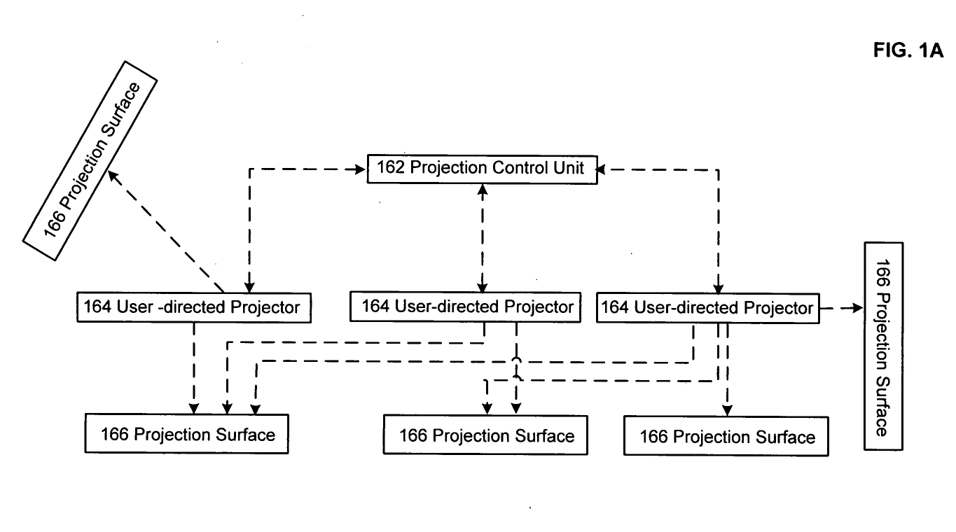

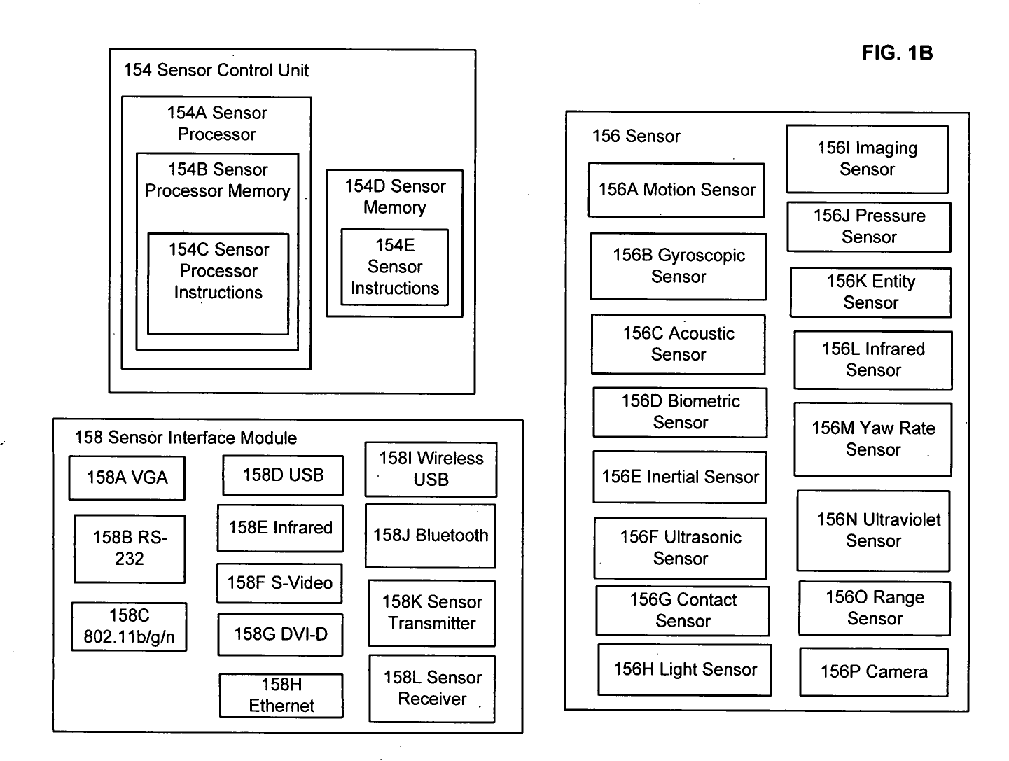

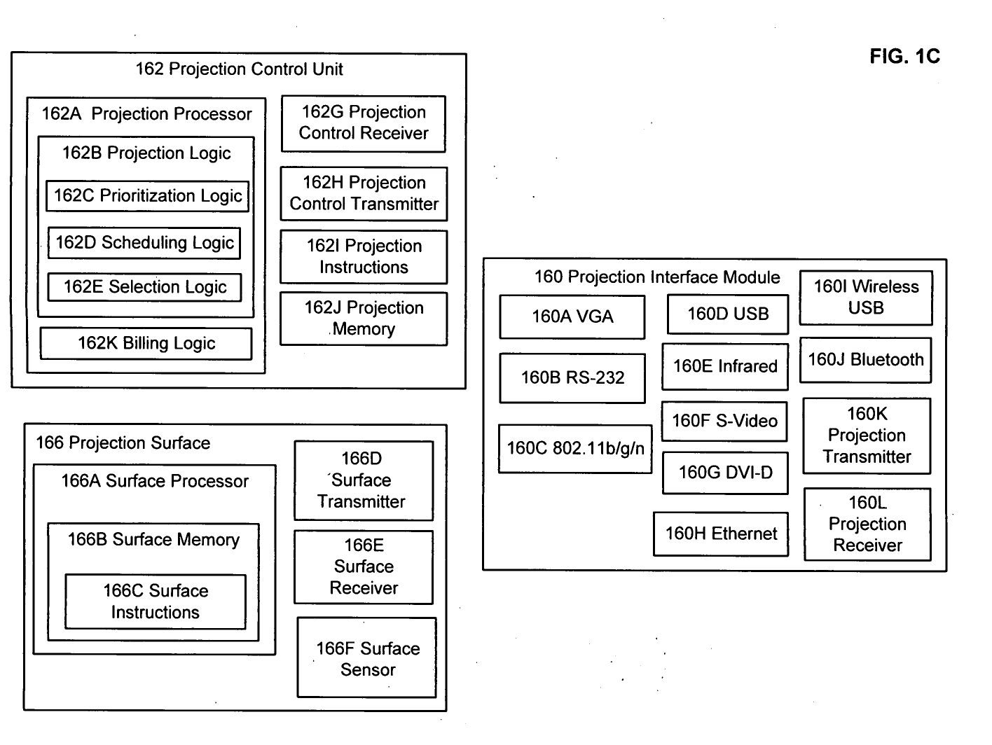

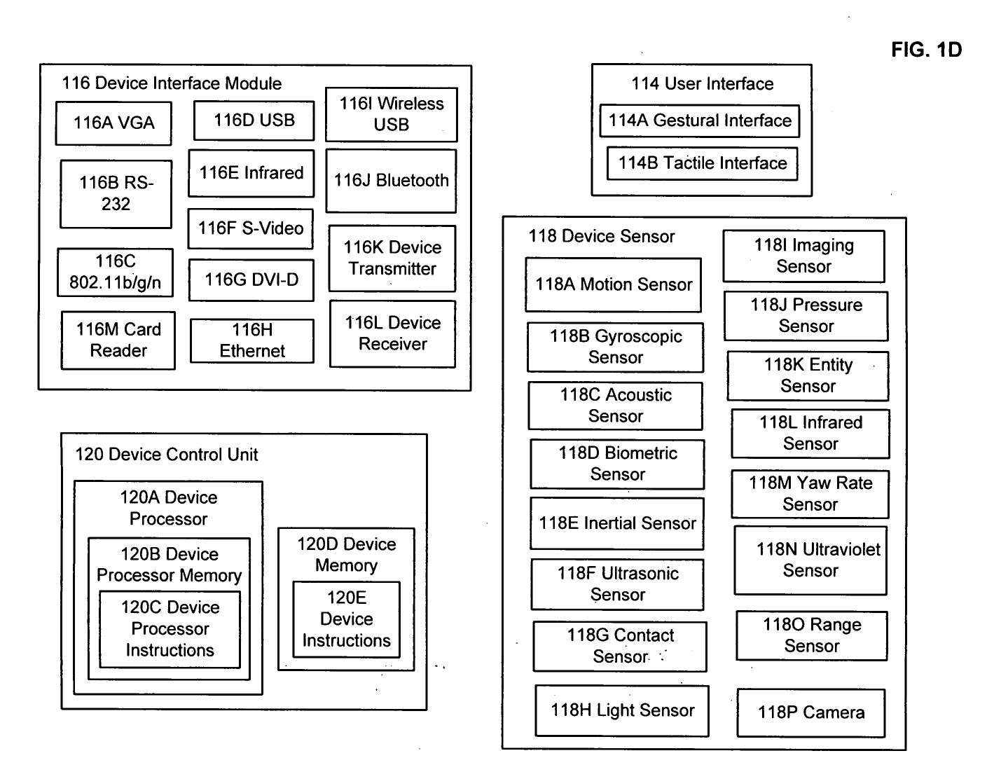

FIG. 1 illustrates an example system 100 in which embodiments may be implemented. In some embodiments, system 100 may include one or more user communications devices 112. In some embodiments, system 100 may include one or more user interfaces 114. In some embodiments, system 100 may include one or more device interface modules 116. In some embodiments, system 100 may include one or more device sensors 118. In some embodiments, system 100 may include one or more device control units 120. In some embodiments, system 100 may include one or more sensor control units 154. In some embodiments, system 100 may include one or more sensors 156. In some embodiments, system 100 may include one or more sensor interface modules 158. In some embodiments, system 100 may include one or more projection control units 162. In some embodiments, system 100 may include one or more user-directed projectors 164. In some embodiments, system 100 may include one or more projection interface modules 160. In some embodiments, system 100 may include one or more projection surfaces 166. In some embodiments, system 100 may be configured to communicate with one or more communications networks 128. In some embodiments, system 100 may be configured to communicate with one or more service provider modules 130. In some embodiments, a service provider module 130 may include one or more service provider receivers 132A. In some embodiments, a service provider module 130 may include one or more service provider transmitters 132B. In some embodiments, a service provider module 130 may include one or more processors 134. In some embodiments, a service provider module 130 may include user identification logic 136. In some embodiments, a service provider module 130 may include billing logic 140. In some embodiments, a service provider module 130 may include user authentication logic 138. In some embodiments, a service provider module 130 may include access logic 142. In some embodiments, a service provider module 130 may include memory 144. In some embodiments, a service provider module 130 may include one or more user identification databases 146. In some embodiments, a service provider module 130 may include user data 148. In some embodiments, a service provider module 130 may include identity authentication data 150. In some embodiments, system 100 may be configured to communicate with one or more financial entities 122. In some embodiments, a financial entity 122 may include one or more user accounts 124. In some embodiments, system 100 may include financial information 126. In some embodiments, system 100 may include one or more user data accounts 152.

### User Communications Device

In some embodiments, system 100 may include one or more user communications devices 112. A user communications device 112 may be configured in numerous ways. For example, in some embodiments, a user communications device 112 may be configured as a personal digital assistant (PDA). In some embodiments, a user communications device 112 may be configured as a cellular telephone. In some embodiments, a user communications device 112 may be configured as a computer (e.g., a laptop computer).

In some embodiments, a user communications device 112 may be operably associated with one or more user interfaces 114. User interfaces 114 may be configured in numerous ways. Examples of such configurations include, but are not limited to, touchscreens, keyboards, and the like. In some embodiments, a user interface 114 may be configured as a gestural user interface 114A. For example, in some embodiments, a user interface 114 may be configured to respond to one or more physical actions. Examples of such physical actions include, but are not limited to, acceleration, negative acceleration, shock, squeeze, movement (e.g., substantially defined motions), and the like. In some embodiments, one or more user interfaces 114 may be configured to be programmable to respond to one or more gestures. For example, in some embodiments, one or more user interfaces 114 may be configured to respond to pressure produced by squeezing the user interface 114. In some embodiments, one or more user interfaces 114 may be configured to respond to one or more motions. Accordingly, one or more user interfaces 114 may be configured to respond to numerous types of gestures. In some embodiments, one or more user interfaces 114 may be configured to include one or more tactile interfaces 114B. In some embodiments, one or more user interfaces 114 may be configured to utilize vibration to interact with a user 110. For example, in some embodiments, a user interface 114 may be configured to vibrate if a user communications device 112 enters into proximity with one or more available projection control units 162. Accordingly, a user interface 114 may be configured to utilize numerous tactile interfaces 114B.

In some embodiments, a user communications device 112 may be operably associated with one or more device interface modules 116. In some embodiments, one or more device interface modules 116 may be configured to operably communicate with one or more user-directed projectors 164. In some embodiments, one or more projection interface modules 160 may be configured to operably communicate with one or more projection control units 162. In some embodiments, one or more projection interface modules 160 may be configured to operably communicate with one or more projection interface modules 160. In some embodiments, one or more device interface modules 116 may be configured to operably communicate with one or more service provider receivers 132A. In some embodiments, one or more device interface modules 116 may be configured to operably communicate with one or more service provider transmitters 132B. In some embodiments, one or more device interface modules 116 may be configured to operably communicate with one or more service provider modules 130. In some embodiments, one or more device interface modules 116 may be configured to operably communicate with one or more sensors 156. In some embodiments, one or more device interface modules 116 may be configured to operably communicate with one or more sensor interface modules 158. In some embodiments, one or more device interface modules 116 may be configured to operably communicate with one or more sensor control units 154. In some embodiments, one or more device interface modules 116 may be configured to operably communicate with one or more financial entities 122. In some embodiments, one or more device interface modules 116 may be configured to operably communicate with one or more communications networks 128. A device interface module 116 may communicate with other components of system 100 through use of numerous communication formats and combinations of communications formats. Examples of such formats include, but are not limited to, 116A VGA, 116D USB, 116I wireless USB, 116B RS-232, 116E infrared, 116J Bluetooth, 116C 802.11b/g/n, 116F S-video, 116H Ethernet, 116G DVI-D, and the like. In some embodiments, one or more device interface modules 116 may be configured to receive information 168 from one or more global positioning units 108. In some embodiments, a device interface module 116 may include one or more card readers 116M. In some embodiments, one or more card readers may be configured to read numerous types of cards. Examples of such cards include, but are not limited to, credit cards, prepaid telephone cards, gift cards, and the like.

In some embodiments, a user communications device 112 may be operably associated with one or more device sensors 118. A user communications device 112 may be operably associated with many types of device sensors 118 alone or in combination. Examples of device sensors 118 include, but are not limited to, 118P cameras, 118H light sensors, 118O range sensors, 118G contact sensors, 118K entity sensors, 118L infrared sensors, 118M yaw rate sensors, 118N ultraviolet sensors, 118E inertial sensors, 118F ultrasonic sensors, 118I imaging sensors, 118J pressure sensors, 118A motion sensors, 118B gyroscopic sensors, 118C acoustic sensors, 118D biometric sensors, and the like. In some embodiments, one or more device sensors 118 may be configured to detect motion. In some embodiments, one or more device sensors 118 may be configured to detect motion that is imparted to one or more user communications devices 112. In some embodiments, one or more device sensors 118 may be configured to detect one or more user-directed projectors 164. In some embodiments, one or more device sensors 118 may be configured to detect one or more projection interface modules 160. In some embodiments, one or more device sensors 118 may be configured to detect one or more projection control units 162. In some embodiments, one or more device sensors 118 may be configured to detect one or more users 110. In some embodiments, one or more device sensors 118 may be configured to detect one or more individuals. In some embodiments, one or more device sensors 118 may be configured to detect one or more additional user communications devices 112.

In some embodiments, a user communications device 112 may be operably associated with one or more device control units 120. In some embodiments, a device control unit 120 may be operably associated with one or more device processors 120A. In some embodiments, a device control unit 120 may be configured to process one or more instructions. For example, in some embodiments, one or more device control units 120 may process information 168 associated with prioritization of projection. In some embodiments, one or more device control units 120 may process information 168 associated with scheduling projection. Accordingly, in some embodiments, one or more device control units 120 may act to control the transmission of information 168 associated with projection. In some embodiments, a device control unit 120 may be operably associated with device processor memory 120B. Accordingly, in some embodiments, device processor memory 120B may include information associated with the operation of the device processor 120A. For example, in some embodiments, device processor memory 120B may include device processor instructions 120C. Device processor instructions 120C may include numerous types of instructions. For example, in some embodiments, device processor instructions 120C may instruct one or more device processors 120A to correlate one or more motions that are imparted to a device with one or more commands. In some embodiments, a device control unit 120 may be operably associated with device memory 120D. Device memory 120D may include numerous types of information. Examples of such information include, but are not limited to, pictures, text, internet addresses, maps, instructions, and the like. In some embodiments, device memory 120D may include device instructions 120E. For example, in some embodiments, device instructions 120E may instruct a device to pair a certain communications protocol with another device (e.g., use of Bluetooth to communicate with a laptop computer).

### Financial Entity

In some embodiments, system 100 may be configured to communicate with one or more financial entities 122. System 100 may be configured to communicate with numerous types of financial entities 122. Examples of such financial entities 122 include, but are not limited to, banks, credit unions, retail stores, credit card companies, issuers of prepaid service cards (e.g., prepaid telephone cards, prepaid internet cards, etc.). In some embodiments, a financial entity 122 may include a user account 124. Examples of such user accounts 124 include, but are not limited to, checking accounts, savings accounts, prepaid service accounts, credit card accounts, and the like.

### Financial Information

In some embodiments, system 100 may include financial information 126. For example, in some embodiments, system 100 may include memory in which financial information 126 may be saved. In some embodiments, system 100 may include access to financial information 126. For example, in some embodiments, system 100 may include access codes that may be used to access financial information 126. In some embodiments, financial information 126 may include information about an individual (e.g., credit history, prepaid accounts, checking accounts, saving accounts, credit card accounts, and the like). In some embodiments, financial information 126 may include information about an institution (e.g., information about an institution that issues credit cards, prepaid service cards, automatic teller machine cards, and the like). Accordingly, in some embodiments, system 100 may be configured to allow a user 110 to access financial information 126 to pay for the use of system 100 or a component thereof. In some embodiments, financial information 126 may include financial transactions (e.g. funds transfers), financial reports (e.g. account statements), financial requests (e.g. credit checks), and the like. Numerous types of financial entities 122 may receive the transmitted financial information 126. The financial entity 122 may include banking systems, credit systems, online payment systems (e.g. PayPal®), bill processing systems, and the like. The financial entity 122 including a user account 124 may be maintained as a component of the service provider module 130 or as an independent service.

### Service Provider Module

In some embodiments, system 100 may be configured to communicate with one or more service provider modules 130. The service provider module 130 may be an integrated or distributed server system associated with one or more communications networks 128. Numerous types of communications networks 128 may be used. Examples of communications networks 128 may include, but are not limited to, a voice over internet protocol (VoIP) network (e.g. networks maintained by Vonage®, Verizon®, Sprint®), a cellular network (e.g. networks maintained by Verizon®, Sprint®, AT&T®, T-Mobile®), a text messaging network (e.g. an SMS system in GSM), an e-mail system (e.g. an IMAP, POP3, SMTP, and/or HTTP e-mail server), and the like.

The service provider module 130 may include one or more service provider receivers 132A. The service provider module 130 may include one or more service provider transmitters 132B. Numerous types of service provider receivers 132A and transmitters 132B may be used. Examples of service provider receivers 132A and transmitters 132B may include, but are not limited to, a cellular transceiver, a satellite transceiver, a network portal (e.g. a modem linked to an internet service provider), and the like.

The service provider module 130 may include a processor 134. Numerous types of processors 134 may be used (e.g. general purpose processors 134 such as those marketed by Intel® and AMD, application specific integrated circuits, and the like). For example, the processor 134 may include, but is not limited to, one or more logic blocks capable of performing one or more computational functions, such as user identification logic 136, user-authentication logic 138, billing logic 140, access logic 142, and the like.

The service provider module 130 may include a memory 144. Numerous types of memory 144 may be used (e.g. RAM, ROM, flash memory, and the like). The memory 144 may include, but is not limited to, a user identification database 146 including user data 148 for one or more users 110. A user identification database 146 item for a user 110 may include one or more fields including identity authentication data 150.

The user data 148 may include data representing various identification characteristics of one or more users 110. The identification characteristics of the one or more users 110 may include, but are not limited to, user names, identification numbers, telephone numbers (e.g., area codes, international codes), images, voice prints, locations, ages, gender, physical trait, and the like.

In some embodiments, a service provider module 130 may be operably associated with one or more processors 134 that include billing logic 140. In some embodiments, billing logic 140 may include, but is not limited to, logic for associating one or more requests related to use of one or more user-directed projectors 164 with one or more fees. For example, in some embodiments, billing logic 140 may include logic that is configured to correlate one or more requests associated with use of one or more user-directed projectors 164 with one or more fees through use of one or more lookup tables. One or more lookup tables may include numerous correlations associated with numerous types of requests with numerous associated fees. Examples of such correlations include, but are not limited to, correlations of: one or more fees with the location of one or more user-directed projectors 164, one or more fees with the location of one or more users, one or more fees with the location of one or more user selected projection surfaces 166, one or more fees with projection of one or more user selected user-directed projectors 164, one or more fees with the use of one or more financial accounts, one or more fees with user provided content, one or more fees with user selected content, one or more fees with club memberships, one or more fees with bank access fees, one or more fees with internet access fees, one or more fees with internet usage fees, one or more fees with additional fees associated with payment methods, and the like. In some embodiments, one or more lookup tables may include combinations of fees with numerous types of requests.

In some embodiments, a service provider module 130 may be configured to select content that is to be projected by one or more user-directed projectors 164. In some embodiments, a service provider module 130 may include one or more processors 140 that are configured to select content that is to be projected by one or more user-directed projectors 164. In some embodiments, a service provider module 130 may include one or more processors 140 that are configured to access content that is to be projected by one or more user-directed projectors 164. In some embodiments, one or more service provider modules 130 may select content that is to be projected in response to one or more requests from one or more users 110. For example, in some embodiments, one or more service provider modules 130 may select content that is appropriate for children in response to a request from a child. In some embodiments, one or more service provider modules 130 may generate one or more instructions to modulate output that is projected by one or more user-directed projectors 164. In some embodiments, one or more service provider modules 130 may generate one or more instructions to modulate the intensity of light that is projected by one or more user-directed projectors 164. In some embodiments, one or more service provider modules 130 may generate one or more instructions to modulate the brightness of light that is projected by one or more user-directed projectors 164. In some embodiments, one or more service provider modules 130 may generate one or more instructions to modulate the contrast of light that is projected by one or more user-directed projectors 164. In some embodiments, service provider modules 130 may generate one or more instructions to modulate the sharpness of light that is projected by one or more user-directed projectors 164.

### Sensor Control Unit

System 100 may include one or more sensor control units 154. In some embodiments, one or more sensor control units 154 may be operably associated with one or more sensors 156. In some embodiments, one or more sensor control units 154 may be operably associated with one or more sensor interface modules 158. In some embodiments, one or more sensor control units 154 may be operably associated with one or more sensor processors 154A. In some embodiments, one or more sensor control units 154 may be operably associated with sensor processor memory 154B. In some embodiments, one or more sensor control units 154 may be operably associated with one or more sensor processor instructions 154C. In some embodiments, one or more sensor control units 154 may be operably associated with sensor memory 154D. In some embodiments, one or more sensor control units 154 may be operably associated with one or more sensor instructions 154E. In some embodiments, one or more sensor control units 154 may facilitate the transmission of one or more signals 170 that include information associated with one or more changes in sensor 156 response. For example, in some embodiments, one or more signals 170 that include information associated with a change in one or more features associated with one or more projection surfaces 166 may be transmitted. The one or more signals 170 may be received by one or more projection control units 162 and used to facilitate projection by one or more user-directed projectors 164 in response to the one or more signals. In some embodiments, one or more sensor control units 154 may use prior sensor response, user input, or other stimulus, to activate or deactivate one or more sensors 156 or other subordinate features contained within one or more sensor control units 154.

### Sensor

System 100 may include one or more sensors 156. In some embodiments, one or more sensors 156 may be operably associated with one or more sensor control units 154. In some embodiments, one or more sensors 156 may be operably associated with one or more sensor interface modules 158. System 100 may include many types of sensors 156 alone or in combination. Examples of sensors 156 include, but are not limited to, 156P cameras, 156H light sensors, 156O range sensors, 156G contact sensors, 156K entity sensors, 156L infrared sensors, 156M yaw rate sensors, 156N ultraviolet sensors, 156E inertial sensors, 156F ultrasonic sensors, 156I imaging sensors, 156J pressure sensors, 156A motion sensors, 156B gyroscopic sensors, 156C acoustic sensors, 156D biometric sensors, and the like. In some embodiments, one or more sensors 156 may be configured to detect motion. In some embodiments, one or more sensors may be configured to detect motion that is imparted to one or more projection surfaces 166. In some embodiments, one or more sensors 156 may be configured to detect the availability of one or more projection surfaces 166.

### Sensor Interface Module

System 100 may include one or more sensor interface modules 158. In some embodiments, one or more sensor interface modules 158 may be operably associated with one or more sensor control units 154. In some embodiments, one or more sensor interface modules 158 may be operably associated with one or more sensors 156. In some embodiments, one or more sensor interface modules 158 may be configured to communicate with one or more user interfaces 114. A sensor interface module 158 may communicate with other components of system 100 through use of numerous communication formats and combinations of communications formats. Examples of such formats include, but are not limited to, 158A VGA, 158D USB, 158I wireless USB, 158B RS-232, 158E infrared, 158J Bluetooth, 158C 802.11b/g/n, 158F S-video, 158H Ethernet, 158G DVI-D, and the like. In some embodiments, a sensor interface module 158 may include one or more sensor transmitters 158K. In some embodiments, a sensor interface module 158 may include one or more sensor receivers 158L.

### Projection Control Unit

System 100 may include one or more projection control units 162. In some embodiments, one or more projection control units 162 may be operably associated with one or more user-directed projectors 164. In some embodiments, one or more projection control units 162 may be operably associated with one or more projection interface modules 160. In some embodiments, one or more projection control units 162 may be operably associated with one or more user-directed projectors 164 and one or more projection interface modules 160. In some embodiments, a projection control unit 162 may be operably associated with one or more projection processors 162A. In some embodiments, a projection control unit 162 may be operably associated with projection memory 162J. In some embodiments, a projection control unit 162 may be operably associated with one or more projection instructions 162I. In some embodiments, a projection control unit 162 may be operably associated with one or more projection control transmitters 162H. In some embodiments, a projection control unit 162 may be operably associated with one or more projection control receivers 162G. In some embodiments, a projection control unit 162 may be operably associated with one or more projection processors 162A that include projection logic 162B. Examples of such projection logic 162B include, but are not limited to, prioritization logic 162C (e.g., logic for prioritizing projection in response to one or more requests from one or more specific individuals), scheduling logic 162D (e.g., logic for scheduling projection in response to the availability of one or more user-directed projectors 164, one or more projection surfaces 166, or the combination of one or more user-directed projectors 164 and one or more projection surfaces 166), selection logic 162E (e.g., logic for selecting content in response to one or more requests from one or more specific individuals), projection logic 162B (e.g., logic for selecting projection parameters in response to one or more features associated with one or more projection surfaces 166), and the like. In some embodiments, a projection control unit 162 may be operably associated with one or more projection processors 162A that include billing logic 162K. In some embodiments, billing logic 162K may include, but is not limited to, logic for associating one or more requests related to use of one or more user-directed projectors 164 with one or more fees. For example, in some embodiments, billing logic 162K may include logic that is configured to correlate one or more requests associated with use of one or more user-directed projectors 164 with one or more fees through use of one or more lookup tables. One or more lookup tables may include numerous correlations associated with numerous types of requests with numerous associated fees. Examples of such correlations include, but are not limited to, correlations of: one or more fees with the location of one or more user-directed projectors 164, one or more fees with the location of one or more users, one or more fees with the location of one or more user selected projection surfaces, one or more fees with projection of one or more user selected user-directed projectors 164, one or more fees with the use of one or more financial accounts, one or more fees with user provided content, one or more fees with user selected content, one or more fees with club memberships, one or more fees with bank access fees, one or more fees with internet access fees, one or more fees with internet usage fees, one or more fees with additional fees associated with payment methods, and the like. In some embodiments, one or more lookup tables may include combinations of fees with numerous types of requests. In some embodiments, a projection control unit 162 may be configured to modulate output projected by one or more user-directed projectors 164. In some embodiments, one or more projection control units 162 may be configured to select one or more wavelengths of light that will be projected by one or more user-directed projectors 164. For example, in some embodiments, one or more projection control units 162 may select one or more wavelengths of ultraviolet light that will be projected by one or more user-directed projectors 164. In some embodiments, one or more projection control units 162 may select one or more wavelengths of visible light that will be projected by one or more user-directed projectors 164. In some embodiments, one or more projection control units 162 may select one or more wavelengths of infrared light that will be projected by one or more user-directed projectors 164. Accordingly, in some embodiments, one or more projection control units 162 may select numerous wavelengths of light that will be projected by one or more user-directed projectors 164.

In some embodiments, one or more projection control units 162 may select content that is to be projected by one or more user-directed projectors 164. In some embodiments, one or more projection control units 162 may select content that is to be projected in response to one or more requests from one or more users 110. For example, in some embodiments, one or more projection control units 162 may select content that is appropriate for children in response to a request from a child. In some embodiments, one or more projection control units 162 may modulate output that is projected by one or more user-directed projectors 164. In some embodiments, one or more projection control units 162 may modulate the intensity of light that is projected by one or more user-directed projectors 164. In some embodiments, one or more projection control units 162 may modulate the brightness of light that is projected by one or more user-directed projectors 164. In some embodiments, one or more projection control units 162 may modulate the contrast of light that is projected by one or more user-directed projectors 164. In some embodiments, one or more projection control units 162 may modulate the sharpness of light that is projected by one or more user-directed projectors 164.

In some embodiments, one or more projection control units 162 may modulate the direction of output that is projected by one or more user-directed projectors 164. In some embodiments, one or more projection control units 162 may direct output from one or more user-directed projectors 164 onto one or more moving projection surfaces 166. In some embodiments, one or more projection control units 162 may direct output from one or more user-directed projectors 164 onto one or more stationary projection surfaces 166. In some embodiments, one or more projection control units 162 may direct output from one or more user-directed projectors 164 onto one or more moving projection surfaces 166 and onto one or more stationary projection surfaces 166. In some embodiments, one or more projection control units 162 may direct output from one or more user-directed projectors 164 onto multiple projection surfaces 166. For example, in some embodiments, one or more projection control units 162 may direct output from one or more user-directed projectors 164 onto a first projection surface 166 and direct output from one or more user-directed projectors 164 onto a second projection surface 166.

In some embodiments, one or more projection control units 162 may dynamically modulate output from one or more user-directed projectors 164. For example, in some embodiments, one or more user-directed projectors 164 may be carried from room to room such that one or more projection control units 162 modulate output from the one or more user-directed projectors 164 in response to the available projection surface 166.

In some embodiments, one or more projection control units 162 may be configured to respond to one or more substantially defined motions. In some embodiments, a user 110 may program one or more projection control units 162 to correlate one or more substantially defined motions with one or more projection commands. For example, in some embodiments, a user 110 may program one or more projection control units 162 to correlate clockwise motion of a user communications device 112 with a command to advance a projected slide presentation by one slide. Accordingly, in some embodiments, a projection control unit 162 may be configured to project in response to substantially defined motions that are programmed according to the preferences of an individual user 110.

### User-Directed Projector

System 100 may include one or more user-directed projectors 164. In some embodiments, a user-directed projector 164 may be operably associated with one or more projection control units 162. In some embodiments, a user-directed projector 164 may be operably associated with one or more projection interface modules 160. In some embodiments, a user-directed projector 164 may be operably associated with one or more projection processors 162A. In some embodiments, a user-directed projector 164 may be operably associated with projection memory 162J. In some embodiments, a user-directed projector 164 may be operably associated with one or more projection instructions 162I. In some embodiments, a user-directed projector 164 may be operably associated with projection logic 162B. In some embodiments, a user-directed projector 164 may be an image stabilized user-directed projector 164.

System 100 may include numerous types of user-directed projectors 164. In some embodiments, a user-directed projector 164 may include inertia and yaw rate sensors that detect motion and provide for adjustment of projected content to compensate for the detected motion. In some embodiments, a user-directed projector 164 may include an optoelectronic inclination sensor and an optical position displacement sensor to provide for stabilized projection (e.g., U.S. Published Patent Application No.: 2003/0038927). In some embodiments, a user-directed projector 164 may include an optoelectronic inclination sensor, an optical position sensitive detector, and a piezoelectric accelerometer that provide for stabilized projection (e.g., U.S. Published Patent Application No.: 2003/0038928). Image stabilized projectors have been described (e.g., U.S. Pat. No. 7,284,866; U.S. Published Patent Application Nos.: 20050280628; 20060103811, and 2006/0187421). In some embodiments, one or more projectors may be modified to become image stabilized projectors. Examples of such projectors have been described (e.g., U.S. Pat. Nos. 6,002,505; 6,764,185; 6,811,264; 7,036,936; 6,626,543; 7,134,078; 7,355,584; U.S. Published Patent Application No.: 2007/0109509).

User-directed projectors 164 may be configured to project numerous wavelengths of light. In some embodiments, a user-directed projector 164 may be configured to project ultraviolet light. In some embodiments, a user-directed projector 164 may be configured to project visible light. In some embodiments, a user-directed projector 164 may be configured to project infrared light. In some embodiments, a user-directed projector 164 may be configured to project numerous combinations of light. For example, in some embodiments, a user-directed projector 164 may project one or more infrared calibration images and one or more visible images.

### Projection Interface Module

System 100 may include one or more projection interface modules 160. In some embodiments, one or more projection interface modules 160 may be operably associated with one or more projection control units 162. In some embodiments, one or more projection interface modules 160 may be operably associated with one or more user-directed projectors 164. A projection interface module 160 may communicate with other components of system 100 through use of numerous communication formats and combinations of communications formats. Examples of such formats include, but are not limited to, 160A VGA, 160D USB, 160I wireless USB, 160B RS-232, 160E infrared, 160J Bluetooth, 160C 802.11b/g/n, 160F S-video, 160H Ethernet, 160G DVI-D, and the like. In some embodiments, a projection interface module 160 may include one or more projection transmitters 160K. In some embodiments, a projection interface module 160 may include one or more projection receivers 160L.

### Projection Surface

System 100 may include one or more projection surfaces 166. In some embodiments, nearly any surface may be utilized as a projection surface 166. In some embodiments, a projection surface 166 may be mounted (e.g., mounted on a wall, ceiling, floor, etc). In some embodiments, a projection surface 166 may be portable. In some embodiments, a projection surface 166 may be carried by an individual person. For example, in some embodiments, a projection surface 166 may be configured as a sheet of material, a tablet, two or more sheets of material that may be separated from each other, and the like. Accordingly, in some embodiments, a projection surface 166 may be configured as a sheet of material that a user 110 may unfold and place on a surface, such as a desk, wall, floor, ceiling, etc. In some embodiments, a projection surface 166 may be a wall, a floor, a ceiling, a portion of a wall, a portion of a floor, a portion of a ceiling, and combinations thereof.

In some embodiments, a projection surface 166 may include one or more surface sensors 166F that are associated with the projection surface 166. In some embodiments, a projection surface 166 may include one or more magnetic surface sensors 166F. For example, in some embodiments, a projection surface 166 may include magnetic surface sensors 166F that are configured to detect magnetic ink that is applied to the projection surface 166. In some embodiments, a projection surface 166 may include one or more pressure surface sensors 166F. For example, in some embodiments, a projection surface 166 may include pressure surface sensors 166F that are configured to detect pressure that is applied to the projection surface 166 (e.g., contact of a stylus with the projection surface 166, contact of a pen with the projection surface 166, contact of a pencil with the projection surface 166, etc.). In some embodiments, a projection surface 166 may include one or more motion surface sensors 166F. For example, in some embodiments, a projection surface 166 may include motion surface sensors 166F that are configured to detect movement associated with the projection surface 166. In some embodiments, a projection surface 166 may include one or more strain surface sensors 166F. For example, in some embodiments, a projection surface 166 may include strain surface sensors 166F that are configured to detect changes in conformation associated with the projection surface 166. In some embodiments, a projection surface 166 may include one or more positional surface sensors 166F (e.g., global positioning surface sensors 166F). For example, in some embodiments, a projection surface 166 may include positional surface sensors 166F that are configured to detect changes in position associated with the projection surface 166.

A projection surface 166 may be constructed from numerous types of materials and combinations of materials. Examples of such materials include, but are not limited to, cloth, plastic, metal, ceramics, paper, wood, leather, glass, and the like. In some embodiments, one or more projection surfaces 166 may exhibit electrochromic properties. In some embodiments, one or more projection surfaces 166 may be coated. For example, in some embodiments, a projection surface 166 may be coated with paint. In some embodiments, a projection surface 166 may include one or more materials that alter light. For example, in some embodiments, a projection surface 166 may convert light (e.g., up-convert light, down-convert light).

In some embodiments, a projection surface 166 may be associated with one or more fiducials. For example, in some embodiments, one or more fluorescent marks may be placed on a projection surface 166. In some embodiments, one or more phosphorescent marks may be placed on a projection surface 166. In some embodiments, one or more magnetic materials may be placed on a projection surface 166. In some embodiments, fiducials may be placed on a projection surface 166 in numerous configurations. For example, in some embodiments, fiducials may be positioned in association with a projection surface 166 such that they form a pattern. In some embodiments, a projection surface 166 may include one or more calibration images.

In some embodiments, a projection surface 166 may include one or more surface transmitters 166D. Accordingly, in some embodiments, a projection surface 166 may be configured to transmit one or more signals 170. Such signals 170 may include numerous types of information 168. Examples of such information 168 may include, but are not limited to, information 168 associated with: one or more positions of one or more projection surfaces 166, one or more conformations of one or more projection surfaces 166, one or more changes in the position of one or more projection surfaces 166, one or more changes in the conformation of one or more projection surfaces 166, one or more motions associated with one or more projection surfaces 166, one or more changes in the motion of one or more projection surfaces 166, and the like.

In some embodiments, a projection surface 166 may include one or more surface receivers 166E. Accordingly, in some embodiments, a projection surface 166 may be configured to receive one or more signals 170. For example, in some embodiments, one or more surface receivers 166E may receive one or more signals 170 that are transmitted by one or more projection transmitters 160K. In some embodiments, one or more surface receivers 166E may receive one or more signals 170 that are transmitted by one or more sensor transmitters 158K.

In some embodiments, a projection surface 166 may include one or more surface processors 166A. Accordingly, in some embodiments, a surface processor 166A may be configured to process information received from one or more surface sensors 166F. In some embodiments, a projection surface 166 may include surface memory 166B. In some embodiments, surface memory 166B may include one or more lookup tables that include correlation information associated with the position of one or more fiducials associated with a projection surface 166 and one or more conformations of the projection surface 166. In some embodiments, surface memory 166B may include surface instructions 166C. In some embodiments, surface instructions 166C may include instructions for a projection surface 166 to transmit one or more signals 170 that indicate that a projection surface 166 has undergone a change in conformation. In some embodiments, surface instructions 166C may include instructions for a projection surface 166 to transmit one or more signals 170 that indicate that a projection surface 166 has undergone a change in position. In some embodiments, surface instructions 166C may include instructions for a projection surface 166 to transmit one or more signals 170 that indicate that a projection surface 166 has undergone a change in motion.

In some embodiments, a projection surface 166 may be configured to include one or more recording attributes. For example, in some embodiments, a projection surface 166 may be configured to communicate with other devices. In some embodiments, a projection surface 166 may be configured to communicate with one or more printers. Accordingly, in some embodiments, a projection surface 166 may be configured to facilitate printing of content that is projected onto the projection surface 166. In some embodiments, a projection surface 166 may be configured to communicate with memory. Accordingly, in some embodiments, a projection surface 166 may be configured to facilitate capture and storage of content that is projected onto the projection surface 166 into memory. In some embodiments, a projection surface 166 may be configured to communicate with one or more communications networks 128. Accordingly, in some embodiments, a projection surface 166 may be configured to facilitate transmission of content that is projected onto the projection surface 166 over one or more communications networks 128. In some embodiments, a projection surface 166 may be configured to communicate with the internet. Accordingly, in some embodiments, a projection surface 166 may be configured to facilitate transmission of content that is projected onto the projection surface 166 over the internet.

### Signal

Numerous types of signals 170 may be used in association with system 100. Examples of such signals 170 include, but are not limited to, analog signals 170, digital signals 170, acoustic signals 170, optical signals 170, radio signals 170, wireless signals 170, hardwired signals 170, infrared signals 170, ultrasonic signals 170, Bluetooth signals 170, 802.11 signals 170, and the like. In some embodiments, one or more signals 170 may not be encrypted. In some embodiments, one or more signals 170 may be encrypted. In some embodiments, one or more signals 170 may be authenticated. In some embodiments, one or more signals 170 may be sent through use of a secure mode of transmission. In some embodiments, one or more signals 170 may be coded for receipt by a specific recipient. In some embodiments, such code may include anonymous code that is specific for the recipient. Accordingly, information 168 included within one or more signals 170 may be protected against being accessed by others who are not the intended recipient. In some embodiments, one or more signals 170 may include information 168 as one or more content packets.

In some embodiments, one or more signals 170 may include processed information 168. In some embodiments, one or more signals 170 may include information 168 that has been processed by one or more sensor processors 154A. For example, in some embodiments, a sensor processor 154A may receive input from one or more sensors 156 that is processed. In some embodiments, this processed information 168 may then be included within a signal 170 that is transmitted. In some embodiments, one or more signals 170 may include processed information 168 that contains information 168 that has been retrieved from sensor processor memory 154B. In some embodiments, one or more signals 170 may include processed information 168 that contains information 168 that has been processed through use of sensor processor instructions 154C. Accordingly, in some embodiments, one or more signals 170 may include numerous types of information 168 that is processed. Examples of such processing may include, but are not limited to, sub-setting, generating projection commands, selecting content, selecting content for projection, selecting content that is not for projection, summarizing sensor data, transforming sensor data, supplementing sensor data, supplementing sensor data with data from external sources, and the like.

In some embodiments, one or more signals 170 may include information 168 that has not been processed. In some embodiments, a sensor transmitter 158K may act as a conduit to transmit one or more signals 170 that include raw data. For example, in some embodiments, one or more sensor transmitters 158K may receive information 168 from one or more sensors 156 and transmit one or more signals 170 that include the unprocessed information 168. Accordingly, in some embodiments, one or more signals 170 may include unprocessed information 168.

### User

System 100 may be operated by one or more users 110. In some embodiments, a user 110 may be human. In some embodiments, a user 110 may be a non-human user 110. For example, in some embodiments, a user 110 may be a computer, a robot, and the like. In some embodiments, a user 110 may be proximate to system 100. In some embodiments, a user 110 may be remote from system 100. In some embodiments, a user 110 may be an individual.

System 100 may be configured in many ways. In some embodiments, system 100 may be configured for use within numerous types of venues. Examples of such venues include, but are not limited to, retail establishments (e.g., department stores, sporting goods stores, clothing stores, shoe stores, hardware stores, and the like), transportation (e.g., airplanes, trains, subways, boats, automobiles, buses, taxi cabs, and the like), food service establishments (e.g., restaurants, coffee shops, cafes, and the like), transportation terminals (e.g., airports, train stations, bus stations, subway stations, boat terminals, and the like), entertainment complexes (e.g., arcades, casinos, theatres, and the like), and the like. For example, in some embodiments, system 100 may be configured to allow a user 110 to enter into a retail establishment and utilize one or more user communications devices 112 to communicate with one or more projection control units 162 to project content. In some embodiments, system 100 may be configured to allow a user 110 to enter into a retail establishment and utilize one or more user communications devices 112 to communicate with one or more service provider modules 130 to project content. In some embodiments, content for projection may be provided by one or more users 110. For example, in some embodiments, one or more users 110 may provide content for projection through use of one or more memory devices (e.g., optical discs, memory sticks, flash memory devices, cellular telephones, personal digital assistants, magnetic discs, and the like). In some embodiments, content for projection may be requested by one or more users 110. For example, in some embodiments, one or more users 110 may utilize system 100 to access content from numerous sources. Examples of such sources that may be accessed to obtain content include, but are not limited to, the internet, memory, databases, electronic mail accounts, video games sites, and the like. In some embodiments, system 100 may be configured to allow one or more users 110 to select one or more user-directed projectors 164 for projection of content. For example, in some embodiments, a user 110 may select one or more user-directed projectors 164 that are located within a venue to project content. In some embodiments, system 100 may be configured to allow one or more users 110 to select one or more projection surfaces 166 for projection of content. For example, in some embodiments, a user 110 may select one or more projection surfaces 166 that are located within a venue to project content. System 100 may be configured to bill for projection. In some embodiments, system 100 may be configured to bill one or more accounts for projection that is requested by a user 110. For example, in some embodiments, system 100 may be configured to allow a user 110 to utilize one or more user-directed projectors 164 to project content within a venue and bill the associated fees for projection to one or more accounts. In some embodiments, system 100 may be configured to bill numerous types of accounts. Examples of such accounts include, but are not limited to, bank accounts, credit card accounts, prepaid accounts, and the like. In some embodiments, system 100 may be configured to facilitate projection of numerous types of content. Examples of such content include, but are not limited to, text (e.g., electronic mail, books, text messages, internet messages, and the like), images (e.g., pictures, graphics, graphs, and the like), video (e.g., video games, movies, webcasts, and the like), and the like. In some embodiments, system 100 may be configured to transmit audio. For example, in some embodiments, system 100 may include one or more speakers and associated control systems that are configured to transmit sounds. Accordingly, in some embodiments, system 100 may be configured to provide individualized projection services to a user 110 that allow a user 110 to select one or more user-directed projectors 164 for projection, one or more projection surfaces 166 onto which content may be projected, or substantially any combination thereof.

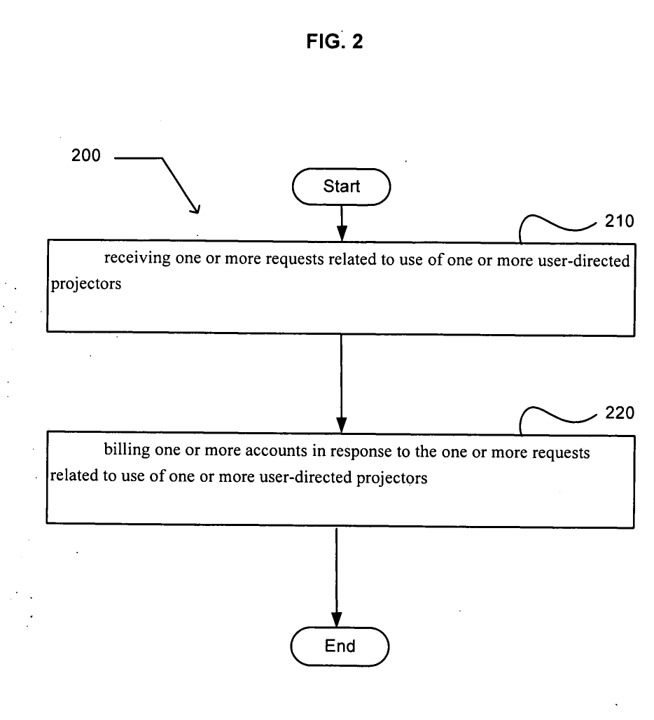

In FIG. 2 and in following figures that include various examples of operations used during performance of a method, discussion and explanation may be provided with respect to any one or combination of the above-described examples of FIG. 1, and/or with respect to other examples and contexts. However, it should be understood that the operations may be executed in a number of other environments and contexts, and/or modified versions of FIG. 1. Also, although the various operations are presented in the sequence(s) illustrated, it should be understood that the various operations may be performed in other orders than those which are illustrated, or may be performed concurrently.

After a start operation, the operational flow 200 includes a receiving operation 210 involving receiving one or more requests related to use of one or more user-directed projectors. In some embodiments, one or more service provider receivers 132A may receive one or more requests related to use of one or more user-directed projectors 164. In some embodiments, one or more service provider receivers 132A may receive one or more signals that include one or more requests related to use of one or more user-directed projectors 164 at one or more times. In some embodiments, one or more service provider receivers 132A may receive one or more requests related to use of one or more user-directed projectors 164 from one or more user communications devices 112. In some embodiments, one or more service provider receivers 132A may receive one or more requests related to projection of user 110 provided content. In some embodiments, one or more service provider receivers 132A may receive one or more requests related to accessing content. In some embodiments, one or more service provider receivers 132A may receive one or more requests related to accessing content for projection. In some embodiments, one or more service provider receivers 132A may receive one or more requests related to projection from one or more user specified projectors. In some embodiments, one or more service provider receivers 132A may receive one or more requests related to projection onto one or more user specified projection surfaces 166. In some embodiments, one or more service provider receivers 132A may receive one or more requests related to use of one or more user-directed projectors 164 at one or more user specified locations. In some embodiments, one or more service provider receivers 132A may receive one or more requests related to use of one or more user-directed projectors 164 at one or more times. In some embodiments, one or more service provider receivers 132A may receive one or more requests related to use of one or more user-directed projectors 164 for one or more time periods. Accordingly, in some embodiments, one or more service provider receivers 132A may receive numerous types of requests, and combinations of requests, related to use of one or more user-directed projectors 164.

After a start operation, the operational flow 200 includes a billing operation 220 involving billing one or more accounts in response to the one or more requests related to use of one or more user-directed projectors. In some embodiments, one or more processors 134 may bill one or more accounts in response to the one or more requests related to use of one or more user-directed projectors 164. In some embodiments, one or more processors 134 may bill numerous types of fees to one or more accounts in response to the one or more requests related to use of one or more user-directed projectors 164. For example, in some embodiments, one or more processors 134 may bill one or more monetary amounts to one or more accounts. In some embodiments, one or more processors 134 may bill one or more credits to one or more accounts. For example, in some embodiments, one or more processors 134 may bill frequent flier miles to one or more accounts. In some embodiments, one or more processors 134 may bill one or more credit card related credits to one or more accounts. One or more processors 134 may bill numerous types of accounts. In some embodiments, one or more processors 134 may bill one or more prepaid accounts. For example, in some embodiments, one or more projection control units 162 may be configured to bill one or more prepaid cards. Examples of such prepaid cards include, but are not limited to, prepaid telephone cards, gift cards, prepaid cards offered by retailers, and the like. In some embodiments, one or more processors 134 may be configured to bill one or more user accounts 124 that are associated with a financial entity 122. In some embodiments, one or more processors 134 may bill one or more financial accounts. For example, in some embodiments, one or more processors 134 may be configured to bill one or more bank accounts. In some embodiments, one or more processors 134 may bill one or more credit accounts. For example, in some embodiments, one or more processors 134 may be configured to bill one or more credit cards. Accordingly, in some embodiments, one or more requests for projection may include one or more identifiers that identify one or more accounts that may be billed. For example, in some embodiments, one or more requests for projection may include one or more bank accounts that may be billed. In some embodiments, one or more requests for projection may include one or more passwords that may be used to bill one or more debit cards. In some embodiments, one or more processors 134 may be configured to deposit assets into an account. For example, in some embodiments, one or more processors 134 may be configured to bill one or more accounts for requests that are related to projection and then to deposit the collected assets into another account.

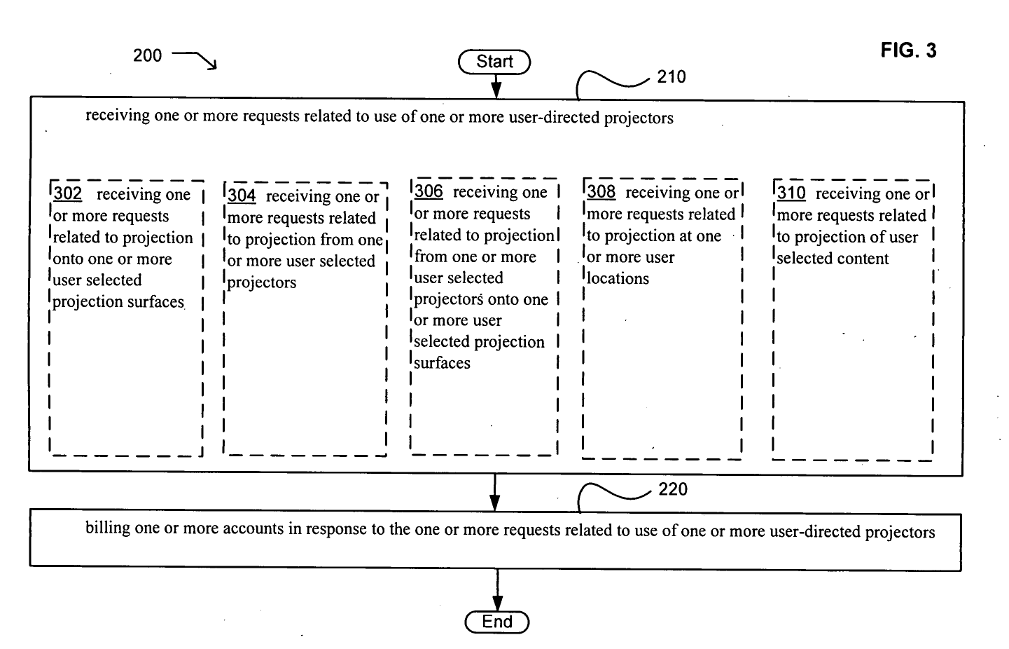

FIG. 3 illustrates alternative embodiments of the example operational flow 200 of FIG. 2. FIG. 3 illustrates example embodiments where the receiving operation 210 may include at least one additional operation. Additional operations may include an operation 302, operation 304, operation 306, operation 308, and/or operation 310.

At operation 302, the receiving operation 210 may include receiving one or more requests related to projection onto one or more user selected projection surfaces. In some embodiments, one or more service provider receivers 132A may receive one or more requests related to projection onto one or more user selected projection surfaces 166. One or more service provider receivers 132A may receive one or more requests related to projection onto user selected projection surfaces 166 that are located in numerous types of venues. Examples of venues in which projection surfaces 166 may be located include, but are not limited to, cafes, hotels, stores (e.g., department stores, grocery stores, sporting goods stores, electronics stores, game stores, furniture stores, etc.), transportation (e.g., airplanes, trains, buses, subways, automobiles, boats, etc.), restaurants, nightclubs, schools, and the like. For example, in some embodiments, a user 110 may request projection onto one or more projection surfaces 166 that are located within a café. Accordingly, in some embodiments, one or more service provider receivers 132A may receive requests for projection onto numerous types of projection surfaces 166. Accordingly, in some embodiments, a user 110 may be allowed to select from numerous projection surfaces 166.

At operation 304, the receiving operation 210 may include receiving one or more requests related to projection from one or more user selected projectors. In some embodiments, one or more service provider receivers 132A may receive one or more requests related to projection from one or more user selected projectors. One or more service provider receivers 132A may receive one or more requests related to use of numerous types of user selected projectors. In some embodiments, one or more user selected projectors may be located in numerous locations. Examples of such locations include, but are not limited to, hotels, transportation (e.g., airplanes, boats, buses, trains, automobiles, subways, and the like), cafes, stores (e.g., department stores, grocery stores, sporting goods stores, electronics stores, game stores, furniture stores, etc.), restaurants, nightclubs, schools, and the like. Accordingly, in some embodiments, one or more service provider receivers 132A may receive one or more requests related to projection from one or more user selected projectors that are located in numerous venues. In some embodiments, one or more service provider receivers 132A may receive one or more requests related to projection from many types of user selected projectors. For example, in some embodiments, one or more service provider receivers 132A may receive one or more requests for projection from a high resolution user selected projector. In some embodiments, one or more service provider receivers 132A may receive one or more requests for projection from a lower resolution user selected projector. In some embodiments, one or more service provider receivers 132A may receive one or more requests for projection from two or more user selected projectors that are configured to project onto the same projection surface.

At operation 306, the receiving operation 210 may include receiving one or more requests related to projection from one or more user selected projectors onto one or more user selected projection surfaces. In some embodiments, one or more service provider receivers 132A may receive one or more requests related to projection from one or more user selected projectors onto one or more user selected projection surfaces 166. One or more service provider receivers 132A may receive one or more requests related to use of numerous types of user selected projectors to project onto one or more user selected projection surfaces 166. In some embodiments, one or more user selected projectors may be located in numerous locations. Examples of such locations include, but are not limited to, hotels, transportation (e.g., airplanes, boats, buses, trains, automobiles, subways, and the like), cafes, stores (e.g., department stores, grocery stores, sporting goods stores, electronics stores, game stores, furniture stores, etc.), restaurants, nightclubs, schools, and the like. Accordingly, in some embodiments, one or more service provider receivers 132A may receive one or more requests related to projection from one or more user selected projectors that are located in numerous venues. In some embodiments, one or more service provider receivers 132A may receive one or more requests related to projection from many types of user selected projectors. For example, in some embodiments, one or more service provider receivers 132A may receive one or more requests for projection from a high resolution user selected projector. In some embodiments, one or more service provider receivers 132A may receive one or more requests for projection from a lower resolution user selected projector. In some embodiments, one or more service provider receivers 132A may receive one or more requests for projection from two or more user selected projectors that are configured to project onto the same projection surface. In addition, one or more service provider receivers 132A may receive one or more requests related to projection onto user selected projection surfaces 166 that are located in numerous types of venues. Examples of venues in which projection surfaces 166 may be located include, but are not limited to, cafes, hotels, stores (e.g., department stores, grocery stores, sporting goods stores, electronics stores, game stores, furniture stores, etc.), transportation (e.g., airplanes, trains, buses, subways, automobiles, boats, etc.), restaurants, nightclubs, schools, and the like. For example, in some embodiments, a user 110 may request projection onto one or more projection surfaces 166 that are located within a café. Accordingly, in some embodiments, one or more service provider receivers 132A may receive requests for projection onto numerous types of projection surfaces 166. Accordingly, in some embodiments, a user 110 may be allowed to select from numerous projection surfaces 166.

At operation 308, the receiving operation 210 may include receiving one or more requests related to projection at one or more user locations. In some embodiments, one or more service provider receivers 132A may receive one or more requests related to projection at one or more user 110 locations. For example, in some embodiments, one or more service provider receivers 132A may receive one or more requests related to projection from one or more user-directed projectors 164 that are proximate to one or more users 110. In some embodiments, one or more service provider receivers 132A may receive one or more requests related to projection onto one or more projection surfaces 166 that are proximate to one or more users 110. In some embodiments, one or more service provider receivers 132A may receive one or more requests that include information 168 related to the location of one or more users 110. In some embodiments, one or more service provider modules 130 may determine the location of one or more users 110. For example, in some embodiments, one or more service provider modules 130 may determine the location of one or more users 110 through receiving the global positioning system coordinates of one or more user communication devices that are used by the user. In some embodiments, one or more service provider modules 130 may determine the location of one or more users 110 through coordinating signals within a cellular communications network that is used by a user communication device.

At operation 310, the receiving operation 210 may include receiving one or more requests related to projection of user selected content. In some embodiments, one or more service provider receivers 132A may receive one or more requests related to projection of user selected content. In some embodiments, one or more service provider receivers 132A may receive one or more requests related to projection of numerous types of user selected content. Examples of such content include, but are not limited to, movies, pictures, text, graphics, video games, electronic mail, and the like.

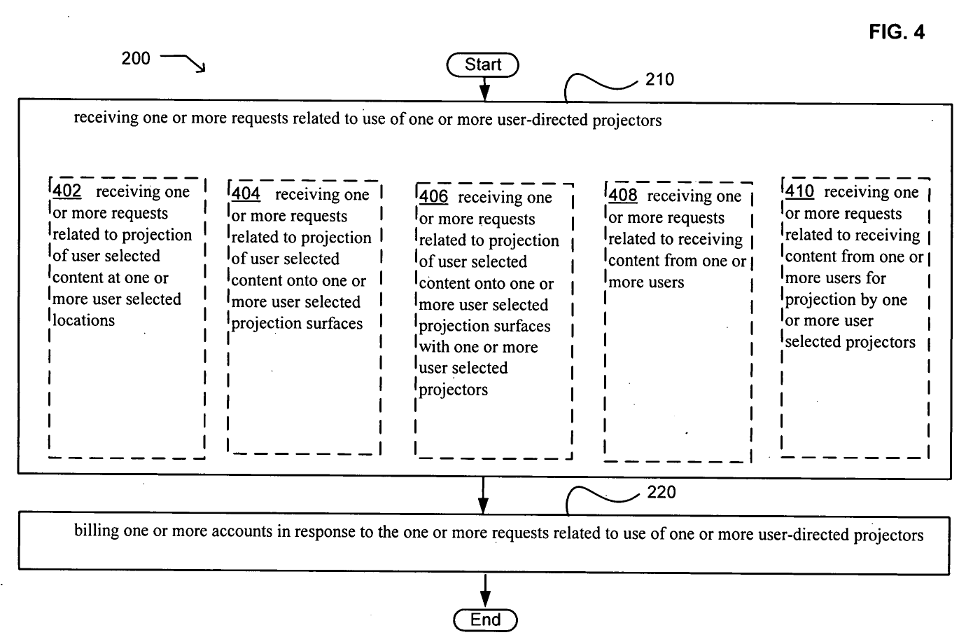

FIG. 4 illustrates alternative embodiments of the example operational flow 200 of FIG. 2. FIG. 4 illustrates example embodiments where the receiving operation 210 may include at least one additional operation. Additional operations may include an operation 402, operation 404, operation 406, operation 408, and/or operation 410.

At operation 402, the receiving operation 210 may include receiving one or more requests related to projection of user selected content at one or more user selected locations. In some embodiments, one or more service provider receivers 132A may receive one or more requests related to projection of user selected content at one or more user selected locations. In some embodiments, one or more service provider receivers 132A may receive one or more requests related to projection of numerous types of user selected content. Examples of such content include, but are not limited to, movies, pictures, text, graphics, video games, electronic mail, and the like. In some embodiments, one or more service provider receivers 132A may receive one or more requests related to projection at numerous types of user selected locations. Examples of such locations include, but are not limited to, hotels, transportation (e.g., airplanes, boats, buses, trains, automobiles, subways, and the like), cafes, stores (e.g., department stores, grocery stores, sporting goods stores, electronics stores, game stores, furniture stores, etc.), restaurants, nightclubs, schools, and the like. Accordingly, in some embodiments, one or more service provider receivers 132A may receive one or more requests related to projection of many types of user selected content at many types of locations.

At operation 404, the receiving operation 210 may include receiving one or more requests related to projection of user selected content onto one or more user selected projection surfaces. In some embodiments, one or more service provider receivers 132A may receive one or more requests related to projection of user selected content onto one or more user selected projection surfaces 166. In some embodiments, one or more service provider receivers 132A may receive one or more requests related to projection of numerous types of user selected content. Examples of such content include, but are not limited to, movies, pictures, text, graphics, video games, electronic mail, and the like. In addition, one or more service provider receivers 132A may receive one or more requests related to projection onto user selected projection surfaces 166 that are located in numerous types of venues. Examples of venues in which projection surfaces 166 may be located include, but are not limited to, cafes, hotels, stores (e.g., department stores, grocery stores, sporting goods stores, electronics stores, game stores, furniture stores, etc.), transportation (e.g., airplanes, trains, buses, subways, automobiles, boats, etc.), restaurants, nightclubs, schools, and the like. For example, in some embodiments, a user 110 may request projection of user selected content onto one or more projection surfaces 166 that are located within a cafe. Accordingly, in some embodiments, one or more service provider receivers 132A may receive requests for projection of user selected content onto numerous types of projection surfaces 166.

At operation 406, the receiving operation 210 may include receiving one or more requests related to projection of user selected content onto one or more user selected projection surfaces with one or more user selected projectors. In some embodiments, one or more service provider receivers 132A may receive one or more requests related to projection of user selected content onto one or more user selected projection surfaces 166 with one or more user selected projectors. In some embodiments, one or more service provider receivers 132A may receive one or more requests related to projection of numerous types of user selected content. Examples of such content include, but are not limited to, movies, pictures, text, graphics, video games, electronic mail, and the like. In addition, one or more service provider receivers 132A may receive one or more requests related to projection onto user selected projection surfaces 166 that are located in numerous types of venues. Examples of venues in which projection surfaces 166 may be located include, but are not limited to, cafes, hotels, stores (e.g., department stores, grocery stores, sporting goods stores, electronics stores, game stores, furniture stores, etc.), transportation (e.g., airplanes, trains, buses, subways, automobiles, boats, etc.), restaurants, nightclubs, schools, and the like. In addition, one or more service provider receivers 132A may receive one or more requests related to projection from one or more user selected projectors. For example, in some embodiments, one or more service provider receivers 132A may receive one or more requests related to projection from one or more high resolution projectors. In some embodiments, one or more service provider receivers 132A may receive one or more requests related to projection from one or more low resolution projectors. For example, in some embodiments, a user 110 may request projection of user selected content onto one or more projection surfaces 166 with one or more user selected projectors that are located within a café. Accordingly, in some embodiments, one or more service provider receivers 132A may receive requests for projection of user selected content onto numerous types of projection surfaces 166 with numerous types of projectors.

At operation 408, the receiving operation 210 may include receiving one or more requests related to receiving content from one or more users. In some embodiments, one or more service provider receivers 132A may receive one or more requests related to receiving content from one or more users 110. In some embodiments, one or more service provider receivers 132A may receive one or more requests related to receiving many types of content from one or more users 110. Examples of such content include, but are not limited to, text, graphics, pictures, electronic mail, movies, and the like. For example, in some embodiments, one or more service provider receivers 132A may receive one or more requests from a user 110 to receive one or more pictures from the one or more users 110 for projection. In some embodiments, one or more service provider receivers 132A may receive content from numerous sources. Examples of such sources on which content may be stored include, but are not limited to, personal digital assistants, cellular telephones, memory sticks, flash drives, optical discs, magnetic tape, magnetic discs, and the like.

At operation 410, the receiving operation 210 may include receiving one or more requests related to receiving content from one or more users for projection by one or more user selected projectors. In some embodiments, one or more service provider receivers 132A may receive one or more requests related to receiving content from one or more users 110 for projection by one or more user selected projectors. In some embodiments, one or more service provider receivers 132A may receive one or more requests related to receiving many types of content from one or more users 110 for projection by one or more user selected projectors. Examples of such content include, but are not limited to, text, graphics, pictures, electronic mail, movies, and the like. For example, in some embodiments, one or more service provider receivers 132A may receive one or more requests from a user 110 to receive one or more pictures from the one or more users 110 for projection. In some embodiments, one or more service provider receivers 132A may receive content from numerous sources. Examples of such sources on which content may be stored include, but are not limited to, personal digital assistants, cellular telephones, memory sticks, flash drives, optical discs, magnetic tape, magnetic discs, and the like. In addition, one or more service provider receivers 132A may receive one or more requests related to projection from one or more user selected projectors. For example, in some embodiments, one or more service provider receivers 132A may receive one or more requests related to projection from one or more high resolution projectors. In some embodiments, one or more service provider receivers 132A may receive one or more requests related to projection from one or more low resolution projectors. For example, in some embodiments, a user 110 may request projection of content received from one or more users 110 with one or more user selected projectors. Accordingly, in some embodiments, one or more service provider receivers 132A may receive requests for projection of content received from one or more users 110 with numerous types of user selected projectors.

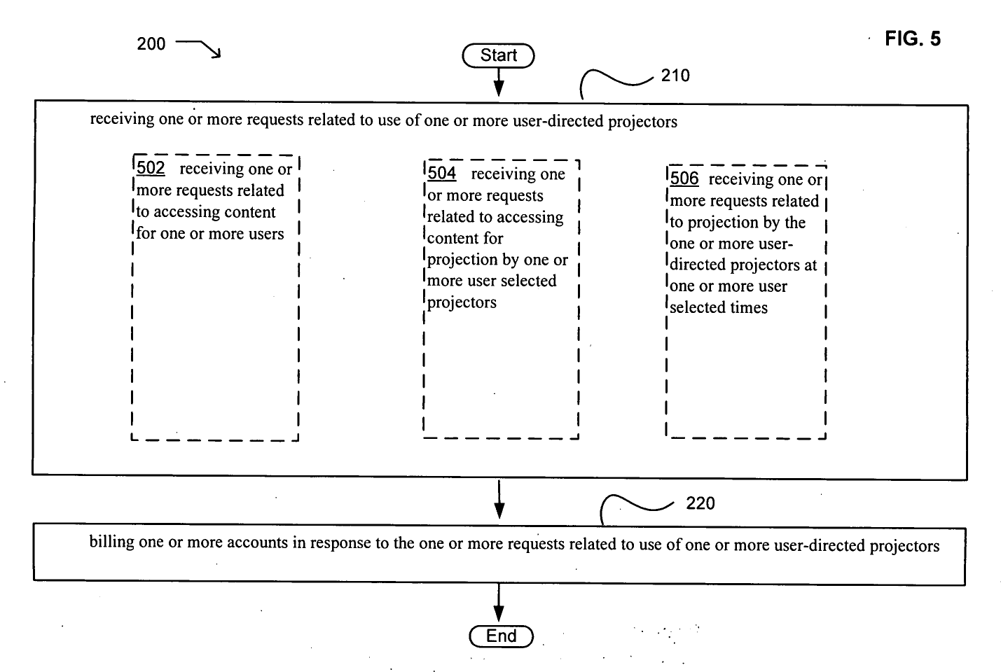

FIG. 5 illustrates alternative embodiments of the example operational flow 200 of FIG. 2. FIG. 5 illustrates example embodiments where the receiving operation 210 may include at least one additional operation. Additional operations may include an operation 502, operation 504, and/or operation 506.

At operation 502, the receiving operation 210 may include receiving one or more requests related to accessing content for one or more users. In some embodiments, one or more service provider receivers 132A may receive one or more requests related to accessing content for one or more users 110. In some embodiments, one or more service provider receivers 132A may receive one or more requests to access content that is contained at numerous sites. Examples of such sites include, but are not limited to, internet sites, memory, lookup tables, databases, and the like. In some embodiments, numerous types of content may be accessed. Examples of such content include, but are not limited to, text, graphics, electronic mail, movies, webcasts, and the like.

At operation 504, the receiving operation 210 may include receiving one or more requests related to accessing content for projection by one or more user selected projectors. In some embodiments, one or more service provider receivers 132A may receive one or more requests related to accessing content for projection by one or more user selected projectors. In some embodiments, one or more service provider receivers 132A may receive one or more requests to access content that is contained at numerous sites for projection by one or more user selected projectors. Examples of such sites include, but are not limited to, internet sites, memory, lookup tables, databases, and the like. In some embodiments, numerous types of content may be accessed. Examples of such content include, but are not limited to, text, graphics, electronic mail, movies, webcasts, and the like. In some embodiments, one or more service provider receivers 132A may receive one or more requests that include matching content that is selected for projection with one or more projectors. For example, in some embodiments, one or more service provider receivers 132A may receive one or more requests to access one or more high definition movies for projection and request one or more high definition projectors to project the high definition movies.

At operation 506, the receiving operation 210 may include receiving one or more requests related to projection by the one or more user-directed projectors at one or more user selected times. In some embodiments, one or more service provider receivers 132A may receive one or more requests related to projection by one or more user-directed projectors 164 at one or more user selected times. For example, in some embodiments, one or more service provider receivers 132A may receive one or more requests for projection at one or more specific times that occur during a day (e.g., 2 PM, 4 AM, 6:30 PM). In some embodiments, one or more service provider receivers 132A may receive one or more requests for projection at one or more time periods occurring during a day (e.g., 2-4 PM, 4-8 AM). In some embodiments, one or more service provider receivers 132A may receive one or more requests for projection within one or more time periods that occur during a day (e.g., between 3 and 4 PM, between 4 and 8 AM). In some embodiments, one or more service provider receivers 132A may receive one or more requests for projection at one or more specific times that occur during a week. In some embodiments, one or more service provider receivers 132A may receive one or more requests for projection at one or more specific times that occur during a month. In some embodiments, one or more service provider receivers 132A may receive one or more requests for projection at one or more specific times that occur during a year. In some embodiments, one or more service provider receivers 132A may receive one or more requests for projection at one or more specific times that occur during a day, week, month, year, or substantially any combination thereof. In some embodiments, one or more service provider receivers 132A may receive one or more requests for projection between one or more times that occur during a day, week, month, year, or substantially any combination thereof. In some embodiments, one or more service provider receivers 132A may receive one or more requests for projection within one or more times periods that occur during a day, week, month, year, or substantially any combination thereof.

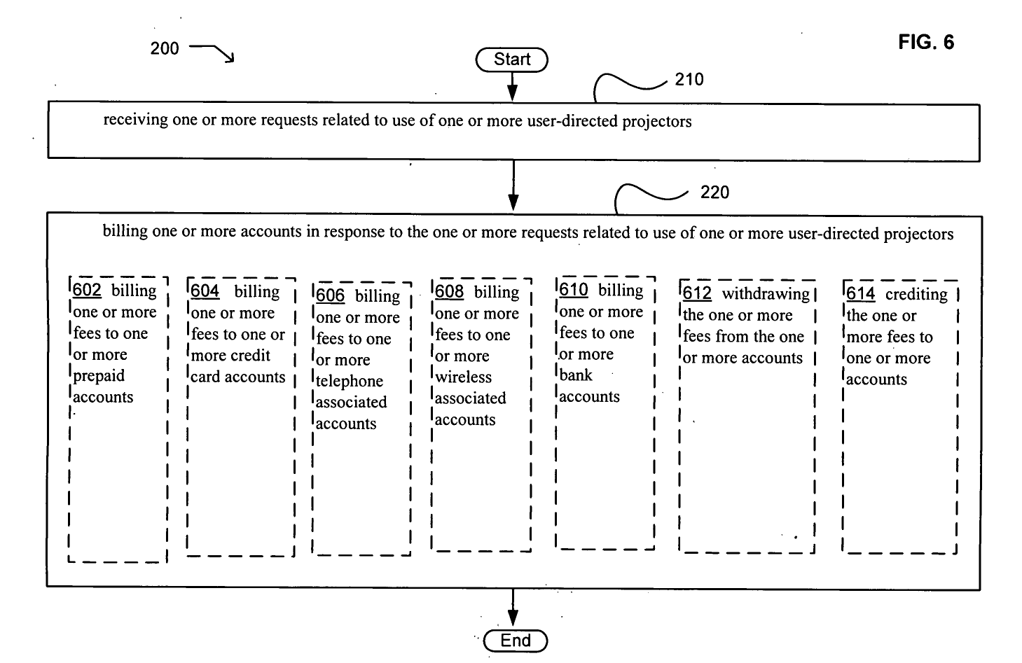

FIG. 6 illustrates alternative embodiments of the example operational flow 200 of FIG. 2. FIG. 6 illustrates example embodiments where the billing operation 220 may include at least one additional operation. Additional operations may include an operation 602, operation 604, operation 606, operation 608, operation 610, operation 612, and/or operation 614.

At operation 602, the billing operation 220 may include billing one or more fees to one or more prepaid accounts. In some embodiments, one or more processors 134 may bill one or more fees to one or more prepaid accounts. Accordingly, in some embodiments, one or more processors 134 may be configured to bill one or more fees to one or more prepaid accounts. In some embodiments, one or more processors 134 may bill one or more fees to one or more prepaid accounts that are issued by a business. For example, in some embodiments, a business may issue a prepaid card that may be billed for projection. Examples of such prepaid cards include, but are not limited to, gift cards, prepaid coffee cards, or other types of cards to which credits may be added. In some embodiments, a business may offer a prepaid account that may be billed for projection. For example, in some embodiments, a gaming arcade may offer a prepaid account the may be billed for projection related to gaming activities. In some embodiments, an airline may offer a prepaid account that may be billed for projection within an airport and/or on an airplane. Accordingly, numerous types of prepaid accounts may be billed for activities related to projection.

At operation 604, the billing operation 220 may include billing one or more fees to one or more credit card accounts. In some embodiments, one or more processors 134 may bill one or more fees to one or more credit card accounts. Accordingly, in some embodiments, one or more processors 134 may be configured to bill one or more fees to one or more credit card accounts. For example, in some embodiments, one or more service provider modules 130 may be configured to contact one or more financial entities 122 and bill one or more fees to one or more credit card accounts that are administered by the one or more financial entities.

At operation 606, the billing operation 220 may include billing one or more fees to one or more telephone associated accounts. In some embodiments, one or more processors 134 may bill one or more fees to one or more telephone associated accounts. Accordingly, in some embodiments, one or more processors 134 may be configured to bill one or more fees to one or more telephone associated accounts. For example, in some embodiments, one or more service provider modules 130 may be configured to contact one or more financial entities 122 that administer one or more telephone accounts and bill one or more fees to one or more telephone accounts that are administered by the one or more financial entities.

At operation 608, the billing operation 220 may include billing one or more fees to one or more wireless associated accounts. In some embodiments, one or more processors 134 may bill one or more fees to one or more wireless associated accounts. Accordingly, in some embodiments, one or more processors 134 may be configured to bill one or more fees to one or more wireless associated accounts. For example, in some embodiments, one or more service provider modules 130 may be configured to contact one or more financial entities 122 that administer one or more wireless accounts and bill one or more fees to one or more wireless accounts that are administered by the one or more financial entities.

At operation 610, the billing operation 220 may include billing one or more fees to one or more bank accounts. In some embodiments, one or more processors 134 may bill one or more fees to one or more bank accounts. Accordingly, in some embodiments, one or more processors 134 may be configured to bill one or more fees to one or more bank accounts. For example, in some embodiments, one or more service provider modules 130 may be configured to contact one or more banks that administer one or more bank accounts and bill one or more fees to one or more bank accounts that are administered by the one or more banks.

At operation 612, the billing operation 220 may include withdrawing one or more fees from the one or more accounts. In some embodiments, one or more processors 134 may withdraw one or more fees from the one or more accounts. Accordingly, in some embodiments, one or more processors 134 may be configured to withdraw one or more fees from one or more accounts. For example, in some embodiments, one or more service provider modules 130 may be configured to contact one or more banks that administer one or more bank accounts and accept the transfer of one or more fees from one or more bank accounts that are administered by the one or more banks. In some embodiments, one or more service provider modules 130 may be configured to contact one or more financial entities 122 that administer one or more credit card accounts and accept the transfer of one or more fees from one or more credit card accounts that are administered by the one or more financial entities. In some embodiments, one or more service provider modules 130 may be configured to contact one or more financial entities 122 that administer one or more prepaid accounts and accept the transfer of one or more fees from one or more prepaid accounts that are administered by the one or more financial entities. Accordingly, in some embodiments, one or more processors 134 may withdraw one or more fees from numerous types of financial entities.

At operation 614, the billing operation 220 may include crediting one or more fees to the one or more accounts. In some embodiments, one or more processors 134 may credit one or more fees to one or more accounts. Accordingly, in some embodiments, one or more processors 134 may be configured to credit one or more fees to one or more accounts. For example, in some embodiments, one or more processors 134 may be configured to accept the transfer of one or more fees from one or more financial entities 122 and then credit one or more accounts with the one or more fees. In some embodiments, one or more processors 134 may be configured to accept the transfer of one or more fees from one or more credit card accounts and then credit one or more accounts with the one or more fees. In some embodiments, one or more processors 134 may be configured to accept the transfer of one or more fees from one or more prepaid accounts and then credit one or more accounts with the one or more fees. Accordingly, in some embodiments, one or more processors 134 may accept transfer of one or more fees from numerous types of financial entities 122 and then credit one or more accounts with the one or more fees.

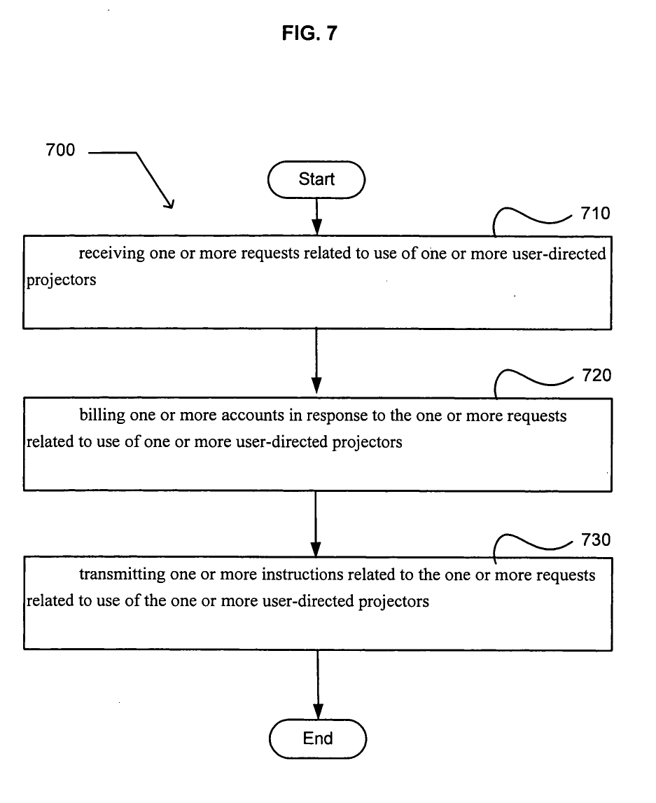

In FIG. 7 and in following figures that include various examples of operations used during performance of a method, discussion and explanation may be provided with respect to any one or combination of the above-described examples of FIG. 1, and/or with respect to other examples and contexts. However, it should be understood that the operations may be executed in a number of other environments and contexts, and/or modified versions of FIG. 1. In some embodiments, operation 210 and 220 of FIG. 2 may correspond to operation 710 and 720 of FIG. 7 respectively. Also, although the various operations are presented in the sequence(s) illustrated, it should be understood that the various operations may be performed in other orders than those which are illustrated, or may be performed concurrently.

After a start operation, the operational flow 700 includes a receiving operation 710 involving receiving one or more requests related to use of one or more user-directed projectors. In some embodiments, one or more service provider receivers 132A may receive one or more requests related to use of one or more user-directed projectors 164. In some embodiments, one or more service provider receivers 132A may receive one or more signals that include one or more requests related to use of one or more user-directed projectors 164 at one or more times. In some embodiments, one or more service provider receivers 132A may receive one or more requests related to use of one or more user-directed projectors 164 from one or more user communications devices 112. In some embodiments, one or more service provider receivers 132A may receive one or more requests related to projection of user 110 provided content. In some embodiments, one or more service provider receivers 132A may receive one or more requests related to accessing content. In some embodiments, one or more service provider receivers 132A may receive one or more requests related to accessing content for projection. In some embodiments, one or more service provider receivers 132A may receive one or more requests related to projection from one or more user specified projectors. In some embodiments, one or more service provider receivers 132A may receive one or more requests related to projection onto one or more user specified projection surfaces 166. In some embodiments, one or more service provider receivers 132A may receive one or more requests related to use of one or more user-directed projectors 164 at one or more user specified locations. In some embodiments, one or more service provider receivers 132A may receive one or more requests related to use of one or more user-directed projectors 164 at one or more times. In some embodiments, one or more service provider receivers 132A may receive one or more requests related to use of one or more user-directed projectors 164 for one or more time periods. Accordingly, in some embodiments, one or more service provider receivers 132A may receive numerous types of requests, and combinations of requests, related to use of one or more user-directed projectors 164.

After a start operation, the operational flow 700 includes a billing operation 720 involving billing one or more accounts in response to the one or more requests related to use of one or more user-directed projectors. In some embodiments, one or more processors 134 may bill one or more accounts in response to the one or more requests related to use of one or more user-directed projectors 164. In some embodiments, one or more processors 134 may bill numerous types of fees to one or more accounts in response to the one or more requests related to use of one or more user-directed projectors 164. For example, in some embodiments, one or more processors 134 may bill one or more monetary amounts to one or more accounts. In some embodiments, one or more processors 134 may bill one or more credits to one or more accounts. For example, in some embodiments, one or more processors 134 may bill frequent flier miles to one or more accounts. In some embodiments, one or more processors 134 may bill one or more credit card related credits to one or more accounts. One or more processors 134 may bill numerous types of accounts. In some embodiments, one or more processors 134 may bill one or more prepaid accounts. For example, in some embodiments, one or more projection control units 162 may be configured to bill one or more prepaid cards. Examples of such prepaid cards include, but are not limited to, prepaid telephone cards, gift cards, prepaid cards offered by retailers, and the like. In some embodiments, one or more processors 134 may be configured to bill one or more user accounts 124 that are associated with a financial entity 122. In some embodiments, one or more processors 134 may bill one or more financial accounts. For example, in some embodiments, one or more processors 134 may be configured to bill one or more bank accounts. In some embodiments, one or more processors 134 may bill one or more credit accounts. For example, in some embodiments, one or more processors 134 may be configured to bill one or more credit cards. Accordingly, in some embodiments, one or more requests for projection may include one or more identifiers that identify one or more accounts that may be billed. For example, in some embodiments, one or more requests for projection may include one or more bank accounts that may be billed. In some embodiments, one or more requests for projection may include one or more passwords that may be used to bill one or more debit cards. In some embodiments, one or more processors 134 may be configured to deposit assets into an account. For example, in some embodiments, one or more processors 134 may be configured to bill one or more accounts for requests that are related to projection and then to deposit the collected assets into another account.

After a start operation, the operational flow 700 includes a transmitting operation 730 involving transmitting one or more instructions related to the one or more requests related to use of the one or more user-directed projectors. In some embodiments, one or more service provider transmitters 132B may transmit one or more instructions related to the one or more requests related to use of the one or more user-directed projectors 164. In some embodiments, one or more service provider transmitters 132B may transmit one or more signals that include one or more instructions related to the one or more requests related to use of the one or more user-directed projectors 164. In some embodiments, one or more service provider transmitters 132B may transmit one or more instructions related to the one or more requests related to use of the one or more user-directed projectors 164 that are configured to be received by one or more projection control units. In some embodiments, one or more service provider transmitters 132B may transmit one or more instructions related to the one or more requests related to use of the one or more user-directed projectors 164 that are configured to be received by one or more projection interface modules. In some embodiments, one or more service provider transmitters 132B may transmit one or more instructions related to the one or more requests related to use of one or more user-directed projectors 164 to project onto one or more user selected projection surfaces 166. In some embodiments, one or more service provider transmitters 132B may transmit one or more instructions related to the one or more requests related to use of one or more user-directed projectors 164 to project with one or more user selected projectors. In some embodiments, one or more service provider transmitters 132B may transmit one or more instructions related to the one or more requests related to use of one or more user-directed projectors 164 to project user selected content. Accordingly, in some embodiments, one or more service provider transmitters 132B may transmit numerous types of instructions that are related to the one or more requests related to use of one or more user-directed projectors 164.

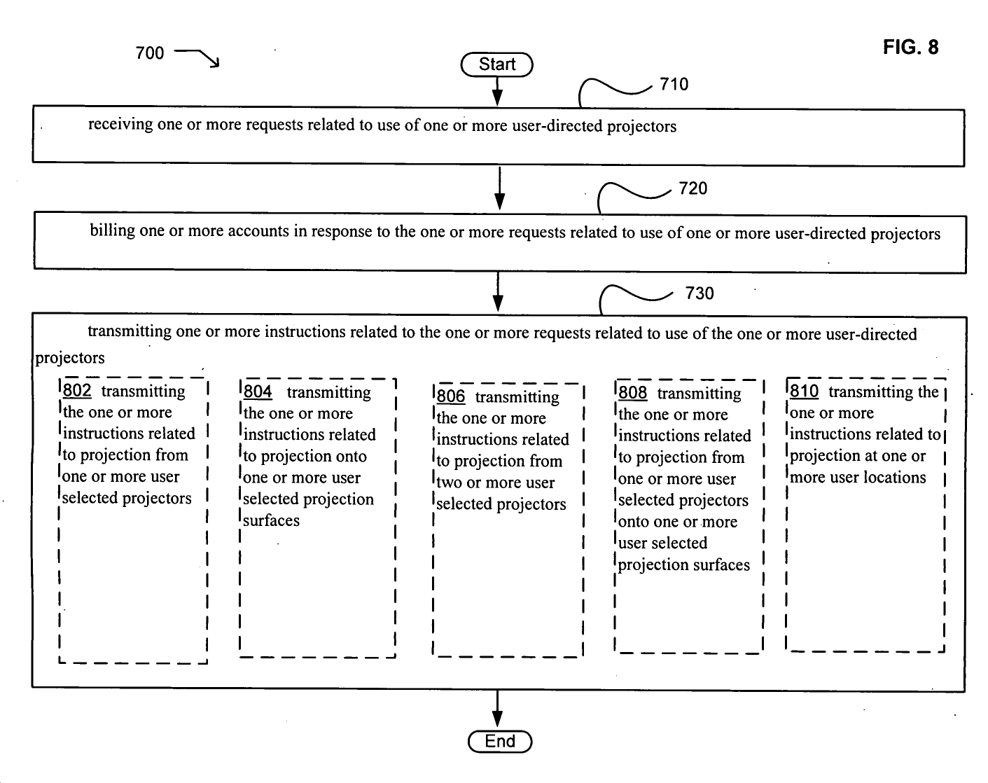

FIG. 8 illustrates alternative embodiments of the example operational flow 700 of FIG. 7. FIG. 8 illustrates example embodiments where the transmitting operation 730 may include at least one additional operation. Additional operations may include an operation 802, operation 804, operation 806, operation 808, and/or operation 810.

At operation 802, the transmitting operation 730 may include transmitting the one or more instructions related to projection from one or more user selected projectors. In some embodiments, one or more service provider transmitters 132B may transmit the one or more instructions related to projection from one or more user selected projectors. In some embodiments, one or more service provider transmitters 132B may transmit one or more instructions related to wavelengths of light that are to be projected. In some embodiments, one or more service provider transmitters 132B may transmit one or more instructions to project one or more wavelengths of light that are matched to one or more projection surfaces 166. For example, in some embodiments, one or more service provider transmitters 132B may transmit one or more instructions to project one or more wavelengths of light that are selected to match the transmission characteristics of one or more projection surfaces 166. In some embodiments, one or more service provider transmitters 132B may transmit one or more instructions to project user selected content from one or more user selected projectors. In some embodiments, one or more service provider transmitters 132B may transmit the one or more instructions to project content that is transmitted for projection by one or more user selected projectors. In some embodiments, one or more service provider transmitters 132B may transmit the one or more instructions to project at one or more times with one or more user selected projectors. In some embodiments, one or more service provider transmitters 132B may transmit the one or more instructions to project during one or more time periods with one or more user selected projectors. In some embodiments, one or more service provider transmitters 132B may transmit the one or more instructions to project within one or more time periods with one or more user selected projectors. In some embodiments, one or more service provider transmitters 132B may transmit the one or more instructions to project onto one or more projection surfaces 166 with one or more user selected projectors. Accordingly, in some embodiments, one or more service provider transmitters 132B may transmit numerous types of instructions related to projection from one or more user selected projectors.

At operation 804, the transmitting operation 730 may include transmitting the one or more instructions related to projection onto one or more user selected projection surfaces. In some embodiments, one or more service provider transmitters 132B may transmit the one or more instructions related to projection onto one or more user selected projection surfaces 166. In some embodiments, one or more service provider transmitters 132B may transmit one or more instructions related to projection onto one or more user selected projection surfaces 166. In some embodiments, one or more service provider transmitters 132B may transmit one or more instructions related to wavelengths of light that are to be projected onto one or more user selected projection surfaces 166. In some embodiments, one or more service provider transmitters 132B may transmit one or more instructions to project one or more wavelengths of light that are matched to one or more user selected projection surfaces 166. For example, in some embodiments, one or more service provider transmitters 132B may transmit one or more instructions to project one or more wavelengths of light that are selected to match to the transmission characteristics of one or more user selected projection surfaces 166. In some embodiments, one or more service provider transmitters 132B may transmit one or more instructions to project user selected content onto one or more user selected projection surfaces 166. In some embodiments, one or more service provider transmitters 132B may transmit the one or more instructions to project content that is transmitted for projection onto one or more user selected projection surfaces 166. In some embodiments, one or more service provider transmitters 132B may transmit the one or more instructions to project at one or more times onto one or more user selected projection surfaces 166. In some embodiments, one or more service provider transmitters 132B may transmit one or more instructions to project during one or more time periods onto one or more user selected projection surfaces 166. In some embodiments, one or more service provider transmitters 132B may transmit the one or more instructions to project within one or more time periods onto one or more user selected projection surfaces 166. In some embodiments, one or more service provider transmitters 132B may transmit the one or more instructions to project onto one or more projection surfaces 166 with one or more projectors. In some embodiments, one or more service provider transmitters 132B may transmit the one or more instructions to project onto one or more projection surfaces 166 with one or more user selected projectors. Accordingly, in some embodiments, one or more service provider transmitters 132B may transmit numerous types of instructions related to projection onto one or more user selected projection surfaces 166.

At operation 806, the transmitting operation 730 may include transmitting the one or more instructions related to projection from two or more user selected projectors. In some embodiments, one or more service provider transmitters 132B may transmit the one or more instructions related to projection from two or more user selected projectors. In some embodiments, one or more service provider transmitters 132B may transmit one or more instructions that include one or more identifiers that are related to two or more user selected projectors. In some embodiments, one or more service provider transmitters 132B may transmit one or more instructions that include one or more identifiers that are related to one or more projection surfaces 166 onto which at least one of the two or more user selected projectors may project. In some embodiments, one or more service provider transmitters 132B may transmit one or more instructions that are related to content that is to be projected from at least one of the two or more user selected projectors. In some embodiments, one or more service provider transmitters 132B may transmit one or more instructions that include content that is to be projected from at least one of the two or more user selected projectors. In some embodiments, one or more service provider transmitters 132B may transmit one or more instructions related to accessing content that is to be projected from at least one of the two or more user selected projectors. In some embodiments, one or more service provider transmitters 132B may transmit one or more instructions that are related to one or more times when content is to be projected from at least one of the two or more user selected projectors. In some embodiments, one or more service provider transmitters 132B may transmit one or more instructions that are related to one or more time periods when content is to be projected from at least one of the two or more user selected projectors. Accordingly, in some embodiments, one or more service provider transmitters 132B may transmit numerous types of instructions that are related to projection from two or more user selected projectors.

At operation 808, the transmitting operation 730 may include transmitting the one or more instructions related to projection from one or more user selected projectors onto one or more user selected projection surfaces. In some embodiments, one or more service provider transmitters 132B may transmit the one or more instructions related to projection from one or more user selected projectors onto one or more user selected projection surfaces 166. In some embodiments, one or more service provider transmitters 132B may transmit one or more instructions that include one or more identifiers that are related to one or more user selected projectors that are to project onto one or more user selected projection surfaces 166. In some embodiments, one or more service provider transmitters 132B may transmit one or more instructions that include one or more identifiers that are related to one or more projection surfaces 166 onto which one or more user selected projectors may project. In some embodiments, one or more service provider transmitters 132B may transmit one or more instructions that are related to content that is to be projected from one or more user selected projectors onto one or more user selected projection surfaces 166. In some embodiments, one or more service provider transmitters 132B may transmit one or more instructions that include content that is to be projected from one or more user selected projectors onto one or more user selected projection surfaces 166. In some embodiments, one or more service provider transmitters 132B may transmit one or more instructions related to accessing content that is to be projected from one or more user selected projectors onto one or more user selected projection surfaces 166. In some embodiments, one or more service provider transmitters 132B may transmit one or more instructions that are related to one or more times when content is to be projected from one or more user selected projectors onto one or more user selected projection surfaces 166. In some embodiments, one or more service provider transmitters 132B may transmit one or more instructions that are related to one or more time periods when content is to be projected from one or more user selected projectors onto one or more user selected projection surfaces 166. Accordingly, in some embodiments, one or more service provider transmitters 132B may transmit numerous types of instructions that are related to projection from one or more user selected projectors onto one or more user selected projection surfaces 166.

At operation 810, the transmitting operation 730 may include transmitting the one or more instructions related to projection at one or more user locations. In some embodiments, one or more service provider transmitters 132B may transmit the one or more instructions related to projection at one or more user 110 locations. In some embodiments, one or more service provider transmitters 132B may transmit one or more instructions related to projection from one or more projectors that are positioned at one or more user 110 locations. In some embodiments, one or more service provider transmitters 132B may transmit one or more instructions related to projection onto one or more projection surfaces 166 that are positioned at one or more user 110 locations. In some embodiments, one or more service provider transmitters 132B may transmit one or more instructions related to projection of content at one or more user 110 locations. In some embodiments, one or more service provider transmitters 132B may transmit one or more instructions that indicate the type of content that may be projected at one or more user 110 locations. For example, in some embodiments, one or more service provider transmitters 132B may transmit one or more instructions that indicate that one or more projectors may project content that is appropriate for children at one or more user 110 locations. In some embodiments, one or more service provider transmitters 132B may transmit one or more instructions that indicate that one or more projectors may project instructional content within a classroom but to not project video games. In some embodiments, one or more service provider transmitters 132B may transmit one or more instructions that indicate one or more times when one or more projectors may project content at one or more user 110 locations. For example, in some embodiments, one or more service provider transmitters 132B may transmit one or more instructions indicating that one or more projectors may project content at one or more user 110 locations until bedtime is reached and then the one or more service provider transmitters 132B may transmit one or more instructions indicating that one or more projectors may not project content at one or more user 110 locations after bedtime. Accordingly, in some embodiments, one or more service provider transmitters 132B may transmit numerous types of instructions related to projection at one or more user 110 locations.

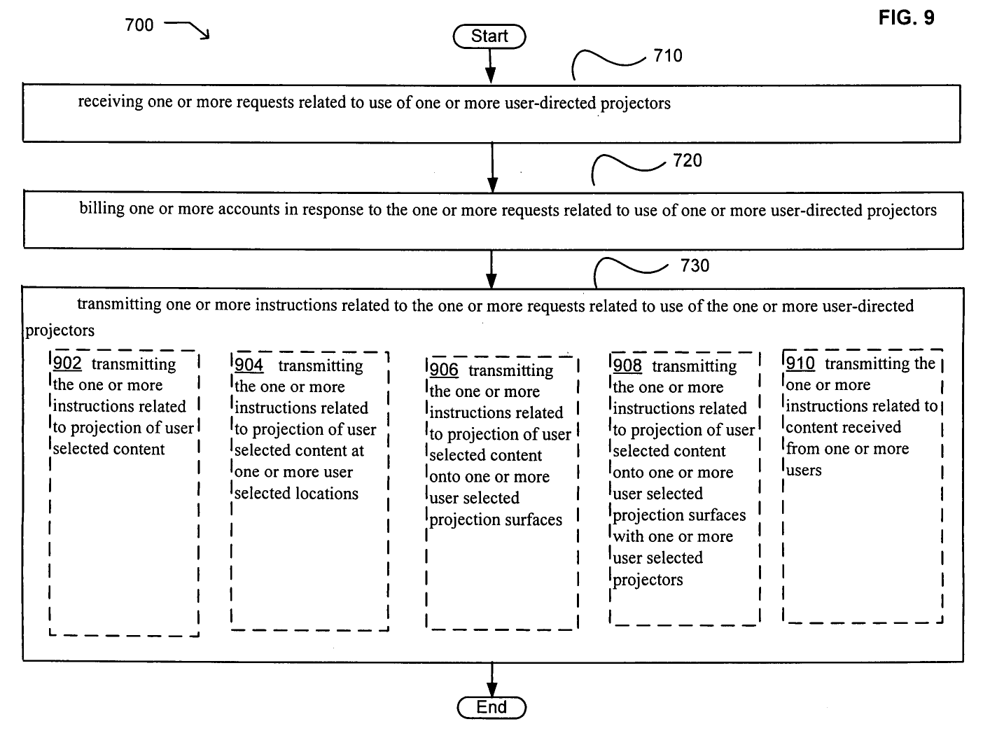

FIG. 9 illustrates alternative embodiments of the example operational flow 700 of FIG. 7. FIG. 9 illustrates example embodiments where the transmitting operation 730 may include at least one additional operation. Additional operations may include an operation 902, operation 904, operation 906, operation 908, and/or operation 910.

At operation 902, the transmitting operation 730 may include transmitting the one or more instructions related to projection of user selected content. In some embodiments, one or more service provider transmitters 132B may transmit the one or more instructions related to projection of user selected content. In some embodiments, one or more service provider transmitters 132B may transmit one or more instructions that include user selected content. In some embodiments, one or more service provider transmitters 132B may transmit one or more instructions related to accessing user selected content. In some embodiments, one or more service provider transmitters 132B may transmit one or more instructions related to permissions related to projection of user selected content. For example, in some embodiments, one or more service provider transmitters 132B may transmit one or more instructions that include one or more passwords that permit user selected content to be projected. In some embodiments, one or more service provider transmitters 132B may transmit one or more instructions that cause a password to be entered before user selected content may be projected. In some embodiments, one or more service provider transmitters 132B may transmit one or more instructions that include information 168 related to where user selected content may be projected. For example, in some embodiments, one or more service provider transmitters 132B may transmit one or more instructions that identify one or more projection surfaces 166 where user selected content may be projected. In some embodiments, one or more service provider transmitters 132B may transmit one or more instructions that identify one or more projectors which may be used to project user selected content. In some embodiments, one or more service provider transmitters 132B may transmit one or more instructions that identify one or more locations where user selected content may be projected. Accordingly, in some embodiments, one or more service provider transmitters 132B may transmit numerous types of instructions that are related to user selected content.

At operation 904, the transmitting operation 730 may include transmitting the one or more instructions related to projection of user selected content at one or more user selected locations. In some embodiments, one or more service provider transmitters 132B may transmit the one or more instructions related to projection of user selected content at one or more user selected locations. In some embodiments, one or more service provider transmitters 132B may transmit one or more instructions that include user selected content that is to be projected at one or more user selected locations. In some embodiments, one or more service provider transmitters 132B may transmit one or more instructions related to accessing user selected content that is to be projected at one or more user selected locations. In some embodiments, one or more service provider transmitters 132B may transmit one or more instructions related to permissions related to projection of user selected content at one or more user selected locations. For example, in some embodiments, one or more service provider transmitters 132B may transmit one or more instructions that include one or more passwords that permit user selected content to be projected at one or more user selected locations. In some embodiments, one or more service provider transmitters 132B may transmit one or more instructions that cause a password to be entered before user selected content may be projected at one or more user selected locations. In some embodiments, one or more service provider transmitters 132B may transmit one or more instructions that identify one or more projectors which may be used to project user selected content at one or more user selected locations. In some embodiments, one or more service provider transmitters 132B may transmit one or more instructions that identify one or more projection surfaces 166 where user selected content may be projected at one or more user selected locations. Accordingly, in some embodiments, one or more service provider transmitters 132B may transmit numerous types of instructions that are related to projection of user selected content at one or more user selected locations.

At operation 906, the transmitting operation 730 may include transmitting the one or more instructions related to projection of user selected content onto one or more user selected projection surfaces. In some embodiments, one or more service provider transmitters 132B may transmit the one or more instructions related to projection of user selected content onto one or more user selected projection surfaces 166. In some embodiments, one or more service provider transmitters 132B may transmit one or more instructions that include user selected content that is to be projected onto one or more user selected projection surfaces 166. In some embodiments, one or more service provider transmitters 132B may transmit one or more instructions related to accessing user selected content that is to be projected onto one or more user selected projection surfaces 166. In some embodiments, one or more service provider transmitters 132B may transmit one or more instructions related to one or more identifiers associated with one or more user selected projection surfaces 166. In some embodiments, one or more service provider transmitters 132B may transmit one or more instructions related to permissions related to projection of user selected content onto one or more user selected projection surfaces 166. For example, in some embodiments, one or more service provider transmitters 132B may transmit one or more instructions that include one or more passwords that permit user selected content to be projected onto one or more user selected projection surfaces 166. In some embodiments, one or more service provider transmitters 132B may transmit one or more instructions that cause a password to be entered before user selected content may be projected onto one or more user selected projection surfaces 166. In some embodiments, one or more service provider transmitters 132B may transmit one or more instructions that identify one or more projectors which may be used to project user selected content onto one or more user selected projection surfaces 166. In some embodiments, one or more service provider transmitters 132B may transmit one or more instructions that identify one or more times when user selected content may be projected onto one or more user selected projection surfaces 166. In some embodiments, one or more service provider transmitters 132B may transmit one or more instructions that identify one or more time periods when user selected content may be projected onto one or more user selected projection surfaces 166. Accordingly, in some embodiments, one or more service provider transmitters 132B may transmit numerous types of instructions that are related to projection of user selected content onto one or more user selected projection surfaces 166.

At operation 908, the transmitting operation 730 may include transmitting the one or more instructions related to projection of user selected content onto one or more user selected projection surfaces with one or more user selected projectors. In some embodiments, one or more service provider transmitters 132B may transmit the one or more instructions related to projection of user selected content onto one or more user selected projection surfaces 166 with one or more user selected projectors. In some embodiments, one or more service provider transmitters 132B may transmit one or more instructions that include user selected content that is to be projected onto one or more user selected projection surfaces 166 with one or more user selected projectors. In some embodiments, one or more service provider transmitters 132B may transmit one or more instructions related to accessing user selected content that is to be projected onto one or more user selected projection surfaces 166 with one or more user selected projectors. In some embodiments, one or more service provider transmitters 132B may transmit one or more instructions related to one or more identifiers associated with one or more user selected projection surfaces 166. In some embodiments, one or more service provider transmitters 132B may transmit one or more instructions related to one or more identifiers associated with one or more user selected projectors. In some embodiments, one or more service provider transmitters 132B may transmit one or more instructions related to permissions related to projection of user selected content onto one or more user selected projection surfaces 166 with one or more user selected projectors. For example, in some embodiments, one or more service provider transmitters 132B may transmit one or more instructions that include one or more passwords that permit user selected content to be projected onto one or more user selected projection surfaces 166. In some embodiments, one or more service provider transmitters 132B may transmit one or more instructions that include one or more passwords that permit user selected content to be projected with one or more user selected projectors. In some embodiments, one or more service provider transmitters 132B may transmit one or more instructions that cause a password to be entered before user selected content may be projected onto one or more user selected projection surfaces 166 with one or more user selected projectors. In some embodiments, one or more service provider transmitters 132B may transmit one or more instructions that identify one or more user selected projectors which may be used to project user selected content onto one or more user selected projection surfaces 166. In some embodiments, one or more service provider transmitters 132B may transmit one or more instructions that identify one or more times when user selected content may be projected onto one or more user selected projection surfaces 166 with one or more user selected projectors. In some embodiments, one or more service provider transmitters 132B may transmit one or more instructions that identify one or more time periods when user selected content may be projected onto one or more user selected projection surfaces 166 with one or more user selected projectors. Accordingly, in some embodiments, one or more service provider transmitters 132B may transmit numerous types of instructions that are related to projection of user selected content onto one or more user selected projection surfaces 166 with one or more user selected projectors.

At operation 910, the transmitting operation 730 may include transmitting the one or more instructions related to content received from one or more users. In some embodiments, one or more service provider transmitters 132B may transmit the one or more instructions related to content received from one or more users 110. In some embodiments, one or more service provider transmitters 132B may transmit one or more instructions that include ratings associated with content received from one or more users 110. For example, in some embodiments, one or more service provider transmitters 132B may transmit one or more instructions that include ratings that are used by the motion picture association of America (e.g., G, PG, PG-13, NC-17, R, and the like). In some embodiments, one or more service provider transmitters 132B may transmit one or more instructions that include projection surfaces 166 on which content received from one or more users 110 may be projected. In some embodiments, one or more service provider transmitters 132B may transmit one or more instructions that include projectors that may be used to project content received from one or more users 110. Accordingly, numerous instructions may be transmitted that are related to content that is received from one or more users 110.

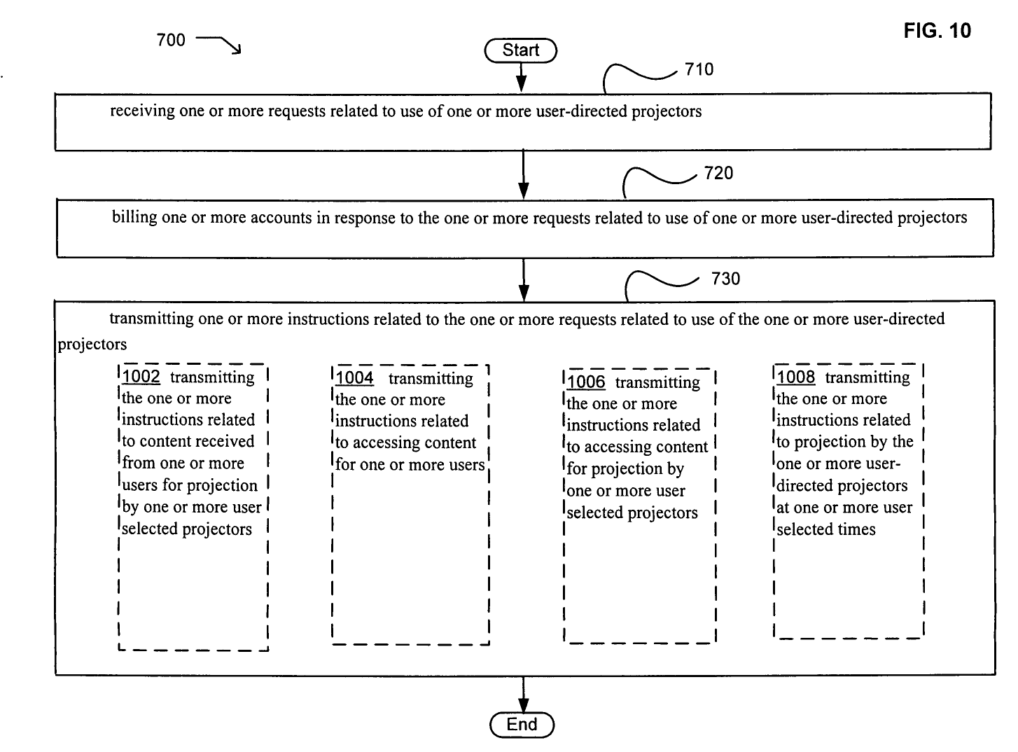

FIG. 10 illustrates alternative embodiments of the example operational flow 700 of FIG. 7. FIG. 10 illustrates example embodiments where the transmitting operation 730 may include at least one additional operation. Additional operations may include an operation 1002, operation 1004, operation 1006, and/or operation 1008.

At operation 1002, the transmitting operation 730 may include transmitting the one or more instructions related to content received from one or more users for projection by one or more user selected projectors. In some embodiments, one or more service provider transmitters 132B may transmit the one or more instructions related to content received from the one or more users 110 for projection by one or more user selected projectors. In some embodiments, one or more service provider transmitters 132B may transmit one or more instructions that include ratings associated with content received from one or more users 110 for projection by one or more user selected projectors. For example, in some embodiments, one or more service provider transmitters 132B may transmit one or more instructions that include ratings that are used by the motion picture association of America (e.g., G, PG, PG-13, NC-17, R, and the like). In some embodiments, one or more service provider transmitters 132B may transmit one or more instructions that include projection surfaces 166 on which content received from one or more users 110 may be projected by one or more user selected projectors. In some embodiments, one or more service provider transmitters 132B may transmit one or more instructions that include the format of content received from one or more users 110 for projection by one or more user selected projectors. Accordingly, numerous instructions may be transmitted that are related to content that is received from one or more users 110 for projection by one or more user selected projectors.

At operation 1004, the transmitting operation 730 may include transmitting the one or more instructions related to accessing content for one or more users. In some embodiments, one or more service provider transmitters 132B may transmit the one or more instructions related to accessing content for the one or more users 110. In some embodiments, one or more service provider transmitters 132B may transmit one or more instructions that include one or more locations where content may be accessed. Examples of such locations include, but are not limited to, internet addresses, memory locations, database locations, lookup table locations, and the like. In some embodiments, one or more service provider transmitters 132B may transmit one or more instructions that include one or more access codes that may be used to access content for one or more users 110. In some embodiments, one or more service provider transmitters 132B may transmit one or more instructions that include one or more passwords that may be used to access content for one or more users 110. In some embodiments, one or more service provider transmitters 132B may transmit one or more instructions that include payment information 168 that may be used to access content for one or more users 110. Accordingly, in some embodiments, one or more service provider transmitters 132B may transmit many kinds of instructions related to accessing content for one or more users 110.

At operation 1006, the transmitting operation 730 may include transmitting the one or more instructions related to accessing content for projection by one or more user selected projectors. In some embodiments, one or more service provider transmitters 132B may transmit the one or more instructions related to accessing content for projection by one or more user selected projectors. In some embodiments, one or more service provider transmitters 132B may transmit one or more instructions that include one or more locations where content may be accessed for projection by one or more user selected projectors. Examples of such locations include, but are not limited to, internet addresses, memory locations, database locations, lookup table locations, and the like. In some embodiments, one or more service provider transmitters 132B may transmit one or more instructions that include one or more access codes that may be used to access content for projection by one or more user selected projectors. In some embodiments, one or more service provider transmitters 132B may transmit one or more instructions that include one or more passwords that may be used to access content for projection by one or more user selected projectors. In some embodiments, one or more service provider transmitters 132B may transmit one or more instructions that include payment information 168 that may be used to access content for projection by one or more user selected projectors. Accordingly, in some embodiments, one or more service provider transmitters 132B may transmit many kinds of instructions related to accessing content for projection by one or more user selected projectors.

At operation 1008, the transmitting operation 730 may include transmitting the one or more instructions related to projection by the one or more user-directed projectors at one or more user selected times. In some embodiments, one or more service provider transmitters 132B may transmit the one or more instructions related to projection by the one or more user-directed projectors 164 at one or more user selected times. In some embodiments, one or more service provider transmitters 132B may transmit one or more instructions related to projection by one or more user-directed projectors 164 at one or more user selected times. In some embodiments, one or more service provider transmitters 132B may transmit one or more instructions related to projection by one or more user-directed projectors 164 within one or more user selected time periods. In some embodiments, one or more service provider transmitters 132B may transmit one or more instructions related to projection by one or more user-directed projectors 164 for one or more user selected time periods. Accordingly, in some embodiments, one or more service provider transmitters 132B may transmit many types of instructions related to projection by one or more user-directed projectors 164 at one or more user selected times.

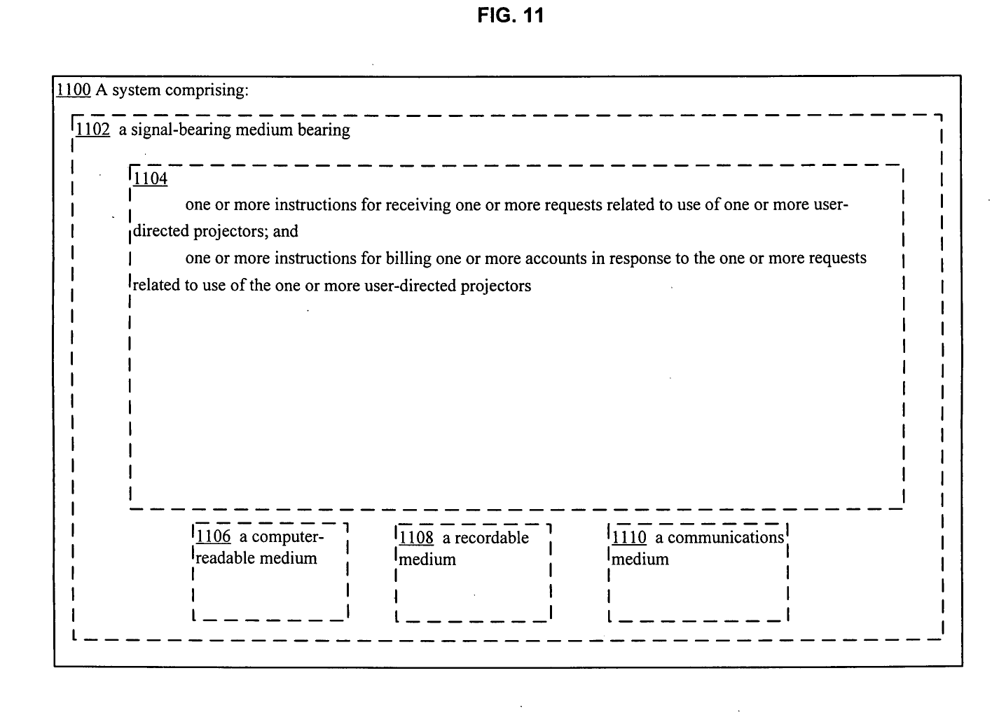

FIG. 11 illustrates a partial view of a system 1100 that includes a computer program 1104 for executing a computer process on a computing device. An embodiment of system 1100 is provided using a signal-bearing medium 1102 bearing one or more instructions for receiving one or more requests related to use of one or more user-directed projectors 164 and one or more instructions for billing one or more accounts in response to the one or more requests related to use of the one or more user-directed projectors 164. The one or more instructions may be, for example, computer executable and/or logic-implemented instructions. In some embodiments, the signal-bearing medium 1102 may include a computer-readable medium 1106. In some embodiments, the signal-bearing medium 1102 may include a recordable medium 1108. In some embodiments, the signal-bearing medium 1102 may include a communications medium 1110.

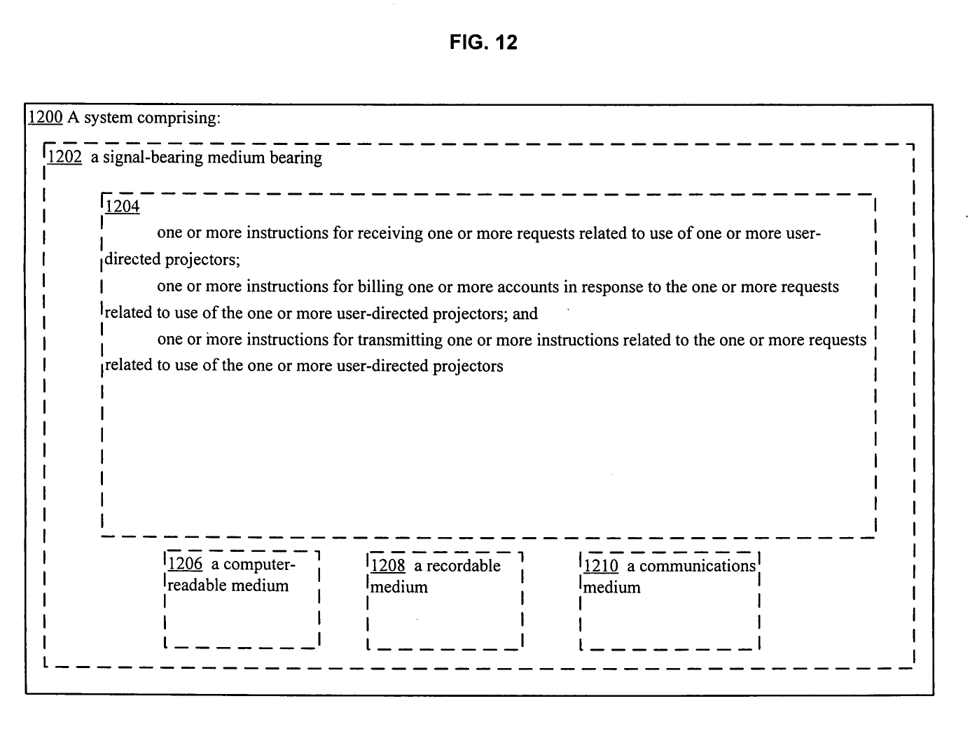

FIG. 12 illustrates a partial view of a system 1200 that includes a computer program 1204 for executing a computer process on a computing device. An embodiment of system 1200 is provided using a signal-bearing medium 1202 bearing one or more instructions for receiving one or more requests related to use of one or more user-directed projectors 164, one or more instructions for billing one or more accounts in response to the one or more requests related to use of the one or more user-directed projectors 164, and one or more instructions for transmitting one or more instructions related to the one or more requests related to use of the one or more user-directed projectors 164. The one or more instructions may be, for example, computer executable and/or logic-implemented instructions. In some embodiments, the signal-bearing medium 1202 may include a computer-readable medium 1206. In some embodiments, the signal-bearing medium 1202 may include a recordable medium 1208. In some embodiments, the signal-bearing medium 1202 may include a communications medium 1210.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces 114, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces 114, drivers, sensors 156, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Those skilled in the art will appreciate that a user 110 may be representative of a human user 110, a robotic user 110 (e.g., computational entity), and/or substantially any combination thereof (e.g., a user 110 may be assisted by one or more robotic agents) unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise. While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1.-36. (canceled)

37. A system comprising:
circuitry for receiving one or more requests related to use of one or more user-directed projectors; and
circuitry for billing one or more accounts in response to the one or more requests related to use of one or more user-directed projectors.

38. The system of claim 37, wherein the circuitry for receiving one or more requests related to use of one or more user-directed projectors comprises:
circuitry for receiving one or more requests related to projection onto one or more user selected projection surfaces.

39. The system of claim 37, wherein the circuitry for receiving one or more requests related to use of one or more user-directed projectors comprises:
circuitry for receiving one or more requests related to projection from one or more user selected projectors.

40. The system of claim 37, wherein the circuitry for receiving one or more requests related to use of one or more user-directed projectors comprises:
circuitry for receiving one or more requests related to projection from one or more user selected projectors onto one or more user selected projection surfaces.

41. The system of claim 37, wherein the circuitry for receiving one or more requests related to use of one or more user-directed projectors comprises:
circuitry for receiving one or more requests related to projection at one or more user locations.

42. The system of claim 37, wherein the circuitry for receiving one or more requests related to use of one or more user-directed projectors comprises:
circuitry for receiving one or more requests related to projection of user selected content.

43. The system of claim 37, wherein the circuitry for receiving one or more requests related to use of one or more user-directed projectors comprises:
circuitry for receiving one or more requests related to projection of user selected content at one or more user selected locations.

44. The system of claim 37, wherein the circuitry for receiving one or more requests related to use of one or more user-directed projectors comprises:
circuitry for receiving one or more requests related to projection of user selected content onto one or more user selected projection surfaces.

45. The system of claim 37, wherein the circuitry for receiving one or more requests related to use of one or more user-directed projectors comprises:
circuitry for receiving one or more requests related to projection of user selected content onto one or more user selected projection surfaces with one or more user selected projectors.

46. The system of claim 37, wherein the circuitry for receiving one or more requests related to use of one or more user-directed projectors comprises:
circuitry for receiving one or more requests related to receiving content from one or more users.

47. The system of claim 37, wherein the circuitry for receiving one or more requests related to use of one or more user-directed projectors comprises:
circuitry for receiving one or more requests related to receiving content from one or more users for projection by one or more user selected projectors.

48. The system of claim 37, wherein the circuitry for receiving one or more requests related to use of one or more user-directed projectors comprises:
circuitry for receiving one or more requests related to accessing content for one or more users.

49. The system of claim 37, wherein the circuitry for receiving one or more requests related to use of one or more user-directed projectors comprises:
circuitry for receiving one or more requests related to accessing content for projection by one or more user selected projectors.

50. The system of claim 37, wherein the circuitry for receiving one or more requests related to use of one or more user-directed projectors comprises:
circuitry for receiving one or more requests related to projection by the one or more user-directed projectors at one or more user selected times.

51. The system of claim 37, wherein the circuitry for billing one or more accounts in response to the one or more requests related to use of one or more user-directed projectors comprises:
circuitry for billing one or more fees to one or more prepaid accounts.

52. The system of claim 37, wherein the circuitry for billing one or more accounts in response to the one or more requests related to use of one or more user-directed projectors comprises:
circuitry for billing one or more fees to one or more credit card accounts.

53. The system of claim 37, wherein the circuitry for billing one or more accounts in response to the one or more requests related to use of one or more user-directed projectors comprises:
circuitry for billing one or more fees to one or more telephone associated accounts.

54. The system of claim 37, wherein the circuitry for billing one or more accounts in response to the one or more requests related to use of one or more user-directed projectors comprises:
circuitry for billing one or more fees to one or more wireless associated accounts.

55. The system of claim 37, wherein the circuitry for billing one or more accounts in response to the one or more requests related to use of one or more user-directed projectors comprises:
circuitry for billing one or more fees to one or more bank accounts.

56. The system of claim 37, wherein the circuitry for billing one or more accounts in response to the one or more requests related to use of one or more user-directed projectors comprises:
circuitry for withdrawing one or more fees from the one or more accounts.

57. The system of claim 37, wherein the circuitry for billing one or more accounts in response to the one or more requests related to use of one or more user-directed projectors comprises:
circuitry for crediting one or more fees to the one or more accounts.

58. The system of claim 37, further comprising:
circuitry for transmitting one or more instructions related to the one or more requests related to use of the one or more user-directed projectors.

59. The system of claim 58, wherein the circuitry for transmitting one or more instructions related to the one or more requests related to use of the one or more user-directed projectors comprises:
circuitry for transmitting the one or more instructions related to projection from one or more user selected projectors.

60. The system of claim 58, wherein the circuitry for transmitting one or more instructions related to the one or more requests related to use of the one or more user-directed projectors comprises:
circuitry for transmitting the one or more instructions related to projection onto one or more user selected projection surfaces.

61. The system of claim 58, wherein the circuitry for transmitting one or more instructions related to the one or more requests related to use of the one or more user-directed projectors comprises:
circuitry for transmitting the one or more instructions related to projection from two or more user selected projectors.

62. The system of claim 58, wherein the circuitry for transmitting one or more instructions related to the one or more requests related to use of the one or more user-directed projectors comprises:
circuitry for transmitting the one or more instructions related to projection from one or more user selected projectors onto one or more user selected projection surfaces.

63. The system of claim 58, wherein the circuitry for transmitting one or more instructions related to the one or more requests related to use of the one or more user-directed projectors comprises:
circuitry for transmitting the one or more instructions related to projection at one or more user locations.

64. The system of claim 58, wherein the circuitry for transmitting one or more instructions related to the one or more requests related to use of the one or more user-directed projectors comprises:
circuitry for transmitting the one or more instructions related to projection of user selected content.

65. The system of claim 58, wherein the circuitry for transmitting one or more instructions related to the one or more requests related to use of the one or more user-directed projectors comprises:
circuitry for transmitting the one or more instructions related to projection of user selected content at one or more user selected locations.

66. The system of claim 58, wherein the circuitry for transmitting one or more instructions related to the one or more requests related to use of the one or more user-directed projectors comprises:
circuitry for transmitting the one or more instructions related to projection of user selected content onto one or more user selected projection surfaces.

67. The system of claim 58, wherein the circuitry for transmitting one or more instructions related to the one or more requests related to use of the one or more user-directed projectors comprises:
circuitry for transmitting the one or more instructions related to projection of user selected content onto one or more user selected projection surfaces with one or more user selected projectors.

68. The system of claim 58, wherein the circuitry for transmitting one or more instructions related to the one or more requests related to use of the one or more user-directed projectors comprises:
circuitry for transmitting the one or more instructions related to content received from one or more users.

69. The system of claim 58, wherein the circuitry for transmitting one or more instructions related to the one or more requests related to use of the one or more user-directed projectors comprises:
circuitry for transmitting the one or more instructions related to content received from one or more users for projection by one or more user selected projectors.

70. The system of claim 58, wherein the circuitry for transmitting one or more instructions related to the one or more requests related to use of the one or more user-directed projectors comprises:
circuitry for transmitting the one or more instructions related to accessing content for one or more users.

71. The system of claim 58, wherein the circuitry for transmitting one or more instructions related to the one or more requests related to use of the one or more user-directed projectors comprises:
circuitry for transmitting the one or more instructions related to accessing content for projection by one or more user selected projectors.

72. The system of claim 58, wherein the circuitry for transmitting one or more instructions related to the one or more requests related to use of the one or more user-directed projectors comprises:
circuitry for transmitting the one or more instructions related to projection by the one or more user-directed projectors at one or more user selected times.

73. A system comprising:
means for receiving one or more requests related to use of one or more user-directed projectors; and
means for billing one or more accounts in response to the one or more requests related to use of one or more user-directed projectors.

74. The system of claim 73, further comprising:
means for transmitting one or more instructions related to the one or more requests related to use of the one or more user-directed projectors.

75. A system comprising:
a signal-bearing medium bearing:
one or more instructions for receiving one or more requests related to use of one or more user-directed projectors; and
one or more instructions for billing one or more accounts in response to the one or more requests related to use of the one or more user-directed projectors.

76. The system of claim 75, further comprising:
one or more instructions for transmitting one or more instructions related to the one or more requests related to use of the one or more user-directed projectors.

77. The system of claim 75, wherein the signal-bearing medium includes a computer-readable medium.

78. The system of claim 75, wherein the signal-bearing medium includes a recordable medium.

79. The system of claim 75, wherein the signal-bearing medium includes a communications medium.
